(19) United States
(12) Patent Application Publication
(10) Pub. No.: US 2020/0002215 A1
(43) Pub. Date: Jan. 2, 2020

(54) Amorphous Silica Products and Methods of Producing Amorphous Silica Products

(71) Applicant: Xaris Holdings, LLC, Spring, TX (US)

(72) Inventors: Scott D. Trom, Spring, TX (US); Bernard G. Pike, Richmond, VA (US)

(73) Assignee: Xaris Holdings, LLC, Spring, TX (US)

(21) Appl. No.: 16/547,965

(22) Filed: Aug. 22, 2019

Related U.S. Application Data
(63) Continuation-in-part of application No. 16/255,302, filed on Jan. 23, 2019.
(60) Provisional application No. 62/620,570, filed on Jan. 23, 2018.

(51) Int. Cl. C03C 1/02; C03C 3/078; C03C 3/085; C01B 33/12

(52) U.S. Cl. CPC C03C 1/024; C03C 3/078; C01P 2002/02; C01B 33/12; C03C 3/085

(57) ABSTRACT

Methods have been developed to produce amorphous silica materials including, but not limited to, glass, container glass, fiber glass, glass bead, sheet or plate glass, glass aggregate, glass sand, abrasives, proppants, foamed glass, and manufactured glass articles. The initial processing steps include preparing a melt batch comprising at least one silica containing component and other processing or product enhancing components, melting the melt batch, and cooling the melted melt batch. The batches include high concentrations of metal oxides, slags, combustible materials, limestone, other product or process enhancing compounds and combinations thereof.

### RELATED APPLICATION

This application claims priority to U.S. provisional patent application No. 62/620,570 filed on Jan. 23, 2018 which is hereby incorporated by reference and as a continuation-in-part to U.S. patent application Ser. No. 16/255,302 filed on Jan. 23, 2019.

### TECHNICAL FIELD

Embodiments of the method of invention comprise producing amorphous silica glass particles, sheets, fibers, articles, or other amorphous silicate products from natural crystalline silica sand, or glass cullet. Natural silica sand is comprised almost entirely of the crystalline form of the silica. However, airborne crystalline silica has been determined to be a hazardous substance that has been shown to cause silicosis if inhaled.

Embodiments of a method include heating crystalline silica sand, gravel, or other particles, (as used herein “crystalline silica sand”) glass cullet, recycled glass, or other glass (as used herein “glass cullet” or “cullet”) or a combination thereof to a temperature in which the crystalline silica is converted into amorphous silica sand, gravel, or other particles, sheets, or fibers. The crystalline silica sand, gravel, or other particles, glass cullet, recycled glass, or a combination thereof may be mixed with other components to provide the desired properties to assist in processing and/or product properties such as, but not limited to, melting temperature, melt viscosity, process efficiency, density, toughness, hardness, or other desired properties. The amorphous silica particles, gravel, or other particles, sheets or fibers may be used as a safe replacement for crystalline silica sand, gravel, or particles, sheets or fibers in consumer and industrial applications wherein dust may be produced during use or installation, for example.

For example, the crystalline silica sand, glass cullet or a combination thereof may be heated in the presence of fluxing components, density increasing components, hardness increasing components and other property enhancing components. The density increasing components may be metal oxides, metal silicates, silicides, aluminum oxide, zirconium oxide, clays comprising aluminum oxide, zirconium oxide, or a combination of aluminum oxide, iron oxide, and zirconium oxide. Other density increasing components include titanium oxide and other transition metal oxides.

Thermal (fuse or melt) processing of crystalline-silica containing minerals (comprising quartz sands and heavy mineral sands) or recycled glass assures the conversion of their crystalline silica content into amorphous silica sands, gravel, or other particles, sheets, or fibers, and, also, kills any microbes present in the feed streams. Therefore, the amorphous silica products are microbe free.

Embodiments also include products produced from the amorphous silica sand, gravel or other particles, sheets, or fibers. For example, embodiments of the products include crystalline silica free sand, gravel, cullet, blasting abrasives, concrete mixes, grout, manufactured stone, mortar, bricks, concrete blocks, other concrete products, pavers, and other products that would benefit and safer with the replacement of crystalline silica with amorphous silica. The amorphous silica products may be a direct replacement for the crystalline silica products.

### BACKGROUND

Crystalline silica is the most abundant mineral on earth. Due to its abundance and low cost, crystalline silica sand, gravel, and rocks have been used for many industrial and consumer applications, including hydraulic fracturing sand, glass production, foundry sand, building materials, sand blasting, recreational sand, as well as other uses. Gravel or coarse aggregate shall herein be defined as any aggregate larger than about 3/16 of an inch. Sand or fine aggregate is defined as any aggregate less than about 3/16 of inch with silt being considered the smallest particles.

However, it has been found that respirable airborne particles of crystalline silica sand may enter the lungs of people in and around any area. Respirable crystalline silica sand in the lungs may result in the development of silicosis and a host of other illnesses. Silicosis is one of the world's oldest known occupational diseases, with reports of employees contracting the disease dating back to ancient Greece.

Airborne crystalline silica dust may be produced during the manufacturing process of the crystalline silica products and also during use or installation of the crystalline silica products. For example, respirable crystalline silica dust becomes airborne, such as during blasting with sand and cutting concrete or bricks, for example.

Abrasive blasting uses compressed air or water to direct a high velocity stream of an abrasive material to clean an object or surface, remove burrs, apply a texture or prepare a surface for painting. Abrasive blasting is more commonly known as sandblasting since silica sand is commonly used as the abrasive, although not the only one always used. Industries that rely on sandblasting on a daily or regular basis include painter who work on large structures like bridges, granite monument makers, foundries and shipbuilders. Industries that rely on sandblasting on a daily or regular basis include any one doing surface preparation work or restoration on large structures like bridges, tanks, pipelines, heavy equipment, shipbuilders, or concrete restoration.

The term “silica” broadly refers to the mineral compound silicon dioxide (SiO2). Although silica can be crystalline or amorphous in form, only the natural crystalline form of silica (and its polymorphs) is hazardous to users that may inhale crystalline silica dust. Owing to its abundance, unique physical and chemical properties, crystalline silica has many uses. Common, commercially produced silica products include quartzite, tripoli, gannister, chert, and novaculite. Crystalline silica also occurs in nature as agate, amethyst, chalcedony, cristobalite, flint, quartz, tridymite, and, in its most common form, silica sand.

Silica sand has been used for many products throughout human history, but one of its most common use is in the production of glass. Table 1-1 summarizes other uses for sand and gravel. In some instances, grinding of sand, gravel, or products containing crystalline silica sand or gravel is required, producing and increasing levels of dust containing hazardous respirable crystalline silica.

TABLE 1
Typical uses of silica sand and gravel

| Product | Major End Use |
|---|---|
| Sand | |
| Glass Making | Containers, flat (plate and window), specialty, |
| | fiberglass (un-ground or ground) |
| Foundry | Molding and core, molding and core facing |
| | (ground) refractory |
| Metallurgical | Silicon carbide, flux for metal smelting |
| Abrasives | Blasting, scouring cleansers (ground), sawing and |
| | sanding, chemicals (ground and un- ground) |
| Fillers | Rubber, paints, putty, whole grain fillers/building |
| | products |
| Ceramic | Pottery, brick, tile, and refractory ceramics |
| Filtration | Water (municipal, county, local), swimming pool, |
| | others |
| Petroleum | Hydraulic fracturing, well packing, and cementing |
| industry | |
| Recreational | Golf courses, baseball, volleyball, play sands, |
| | beaches, traction (engine), roofing granules and |
| | fillers, other (ground silica or whole grain) |
| Gravel | Silica, ferrosilicon, filtration, nonmetallurgical |
| | flux, other |

In March 2016, the Occupational Safety and Health Administration (OSHA) issued a final rule to requiring companies to control exposure to respirable crystalline silica. The rule is comprised of two standards: one for Construction (29 Code of Federal Regulations (CFR) 1926.1153) and the other for General Industry (29 CFR 1910.1053) and Maritime (29 CFR 1915.1053). The Maritime and General Industry standards are the similar, but differ from the Construction standard. The General Industry/Maritime Standard requires the employer to perform air monitoring to determine the eight-hour average exposure level for each affected job task. Employers governed by the Construction standard can either use a control method spelled out for common construction work tasks or perform air monitoring as detailed in the General Industry/Maritime standard.

These requirements can be expensive to implement. To use crystalline silica in the workplace, worker protective measures need to be taken. Initially, airborne crystalline silica sampling needs to be conducted. Once collected, the samples are sent to a laboratory for analysis. The results of this analysis will determine if improved ventilation and/or a change in work practices or respiratory protection is needed.

The new action limit and permissible exposure limit (PEL) for crystalline silica for General Industry, Construction and Maritime are all the same and can be found in Construction (29 CFR 1926.1153), General Industry (29 CFR 1910.1053) or Maritime (29 CFR 1915.1053). The action limit is established at 25 micrograms per cubic meter (ug/m3) and the PEL is established at 50 ug/m3.

To help control the risk of respirable crystalline silica exposure, OSHA's “three lines of defense” philosophy is suggested. The first line of defense is to eliminate and/or engineer the crystalline silica exposure hazard out. This may be best performed by removing the crystalline silica from the workplace. When engineering/elimination controls are not feasible or practical, the second and third lines of defense can be used to help control the crystalline silica exposure hazard. The second line of defense is administrative controls, and the last line of defense to be considered is personal protective equipment (PPE).

OSHA recommends the first engineering control to consider is substitution of the crystalline silica with a nonhazardous product. OSHA suggests using a less toxic abrasive blasting media that can be delivered with water to reduce dust generation. This creates the need for a suitable substitution for the crystalline silica.

The advantages of using a silica substitute outweigh using silica in abrasive sandblasting due to the hazards and compliance with the regulations. The health issues and healthcare costs related to silica would be greatly reduced or eliminated. The time and cost of implementing and maintaining engineering controls would also be eliminated. The disadvantages are that the existing substitutes may not be as hard as a crystalline silica abrasive, nor as dense. Therefore, more of the substitute may need to be used to achieve the same result. It may also be more expensive.

There is a need for a safe substitute for crystalline silica products that do not cause silicosis and do not require strict engineering controls for safe use. There is a further need for an inexpensive, effective amorphous silica sand and amorphous silica gravel for commercial and residential products, including for use as a blasting medium. There is a further need for a water-soluble amorphous silica product.

### SUMMARY

Embodiments of the method may be used to produce amorphous silica materials including, but not limited to, glass, container glass, fiber glass, glass bead, sheet or plate glass, glass aggregate, glass sand, abrasives, proppants, foamed glass, and manufactured glass articles. The initial processing steps include preparing a melt batch comprising at least one silica containing component and other processing or product enhancing components, melting the melt batch, and cooling the melted melt batch. All batches described herein may be thermally processed by melting, fusing or sintering. Sintering or fusing of the components of the batch should be performed sufficiently to convert a significant amount of the crystalline silica into amorphous silica such as below toxicity levels for applications that will result in airborne dust. Further processing steps may be utilized to produce the glass product or article. These finishing processing steps are known in the art and may be applied as known in the art during the cooling step or in addition to the method. Such steps are used to produce the glass, container glass, fiber glass, glass bead, sheet or plate glass, glass aggregate, glass sand, abrasives, proppants, foamed glass, and manufactured glass articles. Therefore, an embodiment described herein to produce an abrasive particle may be modified to change quenching and crushing steps with a molding, air cooling or floating process as known in the art, for example.

Embodiments of the amorphous silica products comprise higher concentrations of metal oxides, such as, but not limited to, iron oxide, alumina, and zirconia, for example. The concentrations of metal oxides result in an amorphous silica product with a density and hardness above the density and hardness of typical recycled glass. The amorphous silica product may be substantially free of deleterious levels of toxic or heavy metals. As used herein, the term “substantially free of deleterious levels of toxic or heavy metals” means that the environmental and industrial hygiene organizations do not consider the amorphous silica product toxic if used as intended.

An embodiment of an amorphous silica product for use as an abrasives, proppants, and sand/sanded products such as, but not limited to, grouts, mortars and concrete, for example, may comprise silicon oxide in the range of 56 wt. % to 80 wt. %, iron oxides in the range of 5 wt. % to 35 wt. %, aluminum oxides in the range of 0 wt. % to 8 wt. %, zirconium oxides in the range of 0 wt. % to 5 wt. %, and modifiers in the range of 0 wt. % to 10 wt. %.

Embodiments of the amorphous silica products including the abrasives, proppants, and sand/sanded products may require the amorphous silica products to be ground to particles. Therefore, embodiments of the amorphous silica products are particles that have been classified into particle size ranges. The embodiments include particles that have a bulk composition consisting essentially of silicon oxide in the range of 56 wt. % to 80 wt. %, iron oxides in the range of 15 wt. % to 35 wt. %, aluminum oxides in the range of 0 wt. % to 8 wt. %, zirconium oxides in the range of 0 wt. % to 5 wt. %, and modifiers in the range of 0 wt. % to 10 wt. %.

The oxides may comprise oxides in multiple forms or valences such as ferric and ferrous oxides. The glass batches may be melted comprising various forms of the metals such as alloys, ores, oxides or silicates, for example, but the amorphous silica product is reported as oxides.

The density of embodiments of certain embodiments of the amorphous silica products is correlated with increasing concentrations of metal oxides in the amorphous silica products including but not limited to, iron oxides, zirconium oxides, aluminum oxides, and combinations thereof, for example. Embodiments of the amorphous silicate products may have a density in the range of 2.5 g/cc to 3.5 g/cc. Embodiments with higher concentrations of iron oxide and/or other metal oxides may have a density in the range of 2.8 g/cc to 3.5 g/cc.

An embodiment of an amorphous silica product for use as abrasives, proppants, and sand/sanded products such as, but not limited to, grouts, mortars and concrete, for example, may comprise silicon oxide in the range of 56 wt. % to 80 wt. %, iron oxides in the range of 10 wt. % to 45 wt. %, aluminum oxides in the range of 0 wt. % to 8 wt. %, zirconium oxides in the range of 0 wt. % to 5 wt. %, and modifiers in the range of 0 wt. % to 10 wt. %. The modifier may be typical fluxes used in glass manufacturing, for example. The embodiments of the amorphous silica product for use as abrasives, proppants, and sand/sanded products may be crushed and classified into particle size ranges. Abrasives, proppants and sands/sanded products are typically classified into different particle size ranges based upon the intended application.

Further, the hardness of embodiments of the amorphous silica product is correlated with increasing iron oxides, zirconium oxides, aluminum oxides, calcium oxides, and combinations thereof. Embodiments of the amorphous silicate product have a Knoop hardness in the range of 520 Hk to 800 Hk. Embodiments with higher concentrations of the metal oxides may have a Knoop hardness in the range of 750 Hk to 850 Hk.

Certain embodiments of the method comprise converting sand, gravel, other minerals and rock naturally comprise converting crystalline or polycrystalline silica (hereinafter, “crystalline silica”) to an amorphous glass sand or gravel. For example, the crystalline silica sand, gravel, other particles, and/or mineral include, but are not limited to, silica sand, silica gravel, quartz sand, any type of heavy mineral sand including garnet, staurolite, and olivine, for example. The amorphous glass sand or gravel may be used in or converted to the commercial and residential applications as described herein.

Embodiments of the method of producing amorphous silica sand or other products comprises converting material comprising crystalline silica into an amorphous glass sand, gravel, or other amorphous product. The conversion may be performed by heating the crystalline silica to a temperature above the temperature that results in the phase change to an amorphous form of silica. In certain embodiments, this temperature may be above the melting temperature of crystalline silica. The melting point of pure silica dioxide is approximately 3110° F. (1710° C.). The melting point may vary based upon the natural composition of the sand, gravel or other rock.

As stated, the melting point of pure silica dioxide is high relative to other materials and processing may be difficult. The melting point of a glass batch comprising crystalline silicas may be, and typically is, lowered by addition of melting temperature reducing agents (fluxes). Thus, in other embodiments, a glass batch may be prepared by mixing the crystalline silica with a melting point reducing agent.

Further, the density of pure amorphous silica may be too low for some applications, such as for an effective abrasive blasting medium. Abrasive blasting media may generally be classified by their specific gravity and hardness. Some properties of the media will affect the efficiency of abrasives in removing coatings or cleaning surfaces including hardness and density, for example. Generally, the greater the difference in hardness between the abrasive media and the coating to be removed or material to be cleaned, the more efficient the blasting process. Higher density particles may also result in a more efficient blasting process because higher density particles with similar contact velocity as lower density particles of approximately the same size will generally have a greater contact force and, therefore, result in a more efficient stripping or cleaning process.

Additionally, a method of producing a water-soluble amorphous silica sand, gravel, or other particles may comprise mixing at least one flux with the crystalline silica dioxide containing material. Embodiments of the method may comprise mixing a flux or fluxes with the silica dioxide containing material wherein at least one of the flux or fluxes mix with the silica dioxide containing material to increase at least one of the density and the hardness of the resulting amorphous silica product relative to pure amorphous silica or container glass.

Metals, and metal oxides may be used as fluxes for crystalline silica dioxide that would result in an amorphous glass product with increased density and/or increased hardness. More conventional glass fluxes may also be added such as, but not limited to, soda ash and potash.

Embodiments include abrasive blasting media and methods of producing abrasive blasting media. Embodiments of the method for producing amorphous silica abrasive blasting materials eliminate the step of collecting, cleaning, and classifying recycled or waste glass. As such, embodiments of the process comprise transforming crystalline or polycrystalline sand, gravel, other particles, or rock that comprise crystalline silica into amorphous sand, gravel, other particles, or rock to reduce the concentration of crystalline silica (a known carcinogen) to safer levels when the amorphous silica sand, gravel or other particle is manufactured or used. Thus, embodiments of the method comprise making these products into a more industrial hygiene friendly substitution for naturally occurring products containing various forms of crystalline silica.

In another embodiment, the process for producing amorphous products consists essentially of heating sand and/or a mineral comprising crystalline silica into an amorphous mass, cooling the amorphous mass to a solid, and forming particles comprising amorphous silica. The particles of amorphous silica may be further crushed or otherwise comminuted to reduce the size of the particles or produce particles having a narrower particle size distribution, for example.

An embodiment of the amorphous silica product or abrasive blasting media comprises silicon oxide in the range of 50 wt. % to 75 wt. %, metals or metal oxides in the range of 20 wt. % to 45 wt. %, and other fluxing compounds in the range of 0 to 10 wt. %. In some embodiments, the other flux compounds or fluxing compounds do not include the metal oxides. The metal oxides include, but are not limited to, iron oxides, aluminum oxides, zirconium oxides, titanium oxides, manganese oxides, magnesium oxides, and combinations thereof. The metal oxides may be added from clays, rock, and/or minerals containing silicates, oxides, or other forms of these metals.

Metals may also be added in their pure metal form or as an alloy. The metals include, but are not limited to, iron, aluminum, titanium, zirconium, manganese, magnesium, alloys and combinations thereof. The metals may be melted in a furnace in the presence of oxygen (air) to at least partially form oxides or in a furnace with an inert atmosphere to melt directly into the amorphous silica.

For example, an embodiment of the amorphous silica product or abrasive blasting media comprises silicon oxide in the range of 50 wt. % to 75 wt. %, iron oxides in the range of 15 wt. % to 45 wt. %, and other fluxing compounds in the range of 0 to 10 wt. %. To reduce the melting point, the other fluxes may be in the range of 1 wt. % to 10 wt. %. This embodiment of the amorphous silica product may comprise either aluminum oxides in the range of 0.5 wt. % to 10 wt. %, zirconium oxides in the range of 0.5 wt. % to 10 wt. %, or a combination thereof.

The fluxing compounds may include any fluxes typically used in glass manufacturing and may include, but are not limited to, those that result in sodium oxides, calcium oxides, magnesium oxides, potassium oxides, lithium oxides, boric oxides, and combinations thereof in the glass.

In some embodiments, the amorphous silica product or abrasive blasting media may comprise a ratio of Si to Fe in the amorphous silica product or abrasive blasting media is in the range of 3:4 to 4:1. Other embodiments, the ratio of Si to Fe in the range of 3:4 to 3:1. In other embodiments, the amorphous silica product may comprise a ratio of Si to the total of Fe and Al in the range of 3:4 to 3:1. In another embodiments, the amorphous silica product may comprise a ratio of Si to the total of Fe and Zr in the range of 3:4 to 3:1. In another embodiments, the amorphous silica product may comprise a ratio of Si to the total of Fe, Zr, and Al in the range of 3:4 to 3:1.

In a still further embodiment of the amorphous silica product or abrasive blasting media comprises silicon oxide in the range of 50 wt. % to 75 wt. %, iron oxides in the range of 25 wt. % to 55 wt. %, and other fluxing compounds in the range of 0 to 10 wt. %. To further reduce the melting point, the other fluxes may be in the range of 1 wt. % to 10 wt. %. This embodiment of the amorphous silica product may comprise aluminum oxides in the range of 0.5 wt. % to 10 wt. %, zirconium oxides in the range of 0.5 wt. % to 10 wt. %, or a combination thereof to produce the desired properties.

In another embodiment of the amorphous silica product or abrasive blasting media comprises silicon oxide in the range of 50 wt. % to 75 wt. %, a combination of iron oxides and one of aluminum oxides, zirconium oxides, or a combination of aluminum oxides and zirconium oxides in the range of 25 wt. % to 60 wt. %, and other fluxing compounds in the range of 0 to 15 wt. %. To further reduce the melting point, the other fluxes may be in the range of 1 wt. % to 15 wt. %.

Another embodiment is directed to an amorphous silica product or an abrasive blasting media consisting essentially of silicon oxide in the range of 50 wt. % to 75 wt. %, iron oxides in the range of 20 wt. % to 40 wt. %; and fluxing compounds in the range of 0 to 15 wt. %.

Embodiments of the method are directed to a method of producing a glass product comprising preparing a melt batch, wherein the melt batch comprises silicon oxide in the range of 55 wt. % to 75 wt. %, at least one of iron, iron silicates, and iron oxides in the range of 18 wt. % to 45 wt. %, and flux or fluxes in the range of 0 wt. % to 20 wt. %. The melt batch is heated to melt the components a glass melt and cooling the glass melt. Cooling the glass melt may comprise quenching the glass melt, air cooling the glass melt, annealing the glass melt or combinations thereof.

In any embodiment, the melt batch consists essentially of silicon oxide in the range of 55 wt. % to 75 wt. %, at least one of iron, iron silicates, and iron oxides in the range of 18 wt. % to 45 wt. %, and other flux components in the range of 0.5 wt. % to 10 wt. %.

A still other embodiment of the amorphous silica product or the abrasive blasting media comprises silicon oxide in the range of 45 wt. % to 75 wt. %, iron oxides in the range of 25 wt. % to 45 wt. %, and fluxing compounds in the range of 0 to 10 wt. %. In some embodiments, the amorphous silica product or abrasive blasting media consists essentially of silicon oxide in the range of 45 wt. % to 75 wt. %, iron oxides in the range of 28 wt. % to 45 wt. %, and fluxing compounds in the range of 0 to 10 wt. %.

An abrasive blasting media comprising or, in some cases consisting essentially of, silicon oxide in the range of 50 wt. % to 75 wt. %, iron oxides and aluminum oxides, wherein the iron oxides and the aluminum oxides together are in in the range of 5 wt. % to 50 wt. %, and fluxing compounds in the range of 0 to 10 wt. %. For this embodiment, the abrasive blasting media may comprise the aluminum oxides in the range of 3 to 10 wt. %.

An abrasive blasting media comprising or, in some cases consisting essentially of, silicon oxide in the range of 50 wt. % to 75 wt. %, iron oxides and aluminum oxides, wherein the iron oxides and the aluminum oxides together are in in the range of 25 wt. % to 50 wt. %, and fluxing compounds in the range of 0 to 10 wt. %. Also, for this embodiment, the abrasive blasting media may comprise the aluminum oxides in the range of 3 to 10 wt. %.

The amorphous silica product or the abrasive blasting media may comprise, or consist essentially of, silicon oxide in the range of 50 wt. % to 75 wt. %, iron oxides and zirconium oxides, wherein the iron oxides and the zirconium oxides together are in in the range of 12 wt. % to 50 wt. %, and fluxing compounds in the range of 0 to 10 wt. %. For this embodiment, the zirconium oxides are in the range of 2 to 10 wt. %.

The amorphous silica product or the abrasive blasting media may comprise, or consist essentially of, silicon oxide in the range of 50 wt. % to 75 wt. %, iron oxides and zirconium oxides, wherein the iron oxides and the zirconium oxides together are in in the range of 25 wt. % to 50 wt. %, and fluxing compounds in the range of 0 to 10 wt. %. For this embodiment, the zirconium oxides are in the range of 2 to 14 wt. %.

In a still other embodiment, an amorphous silica product or abrasive blasting media consists essentially of silicon oxide in the range of 50 wt. % to 75 wt. %, iron oxides in the range of 20 wt. % to 45 wt. %, and fluxing compounds in the range of 4 to 20 wt. %.

Embodiments also include methods of producing an amorphous silica product or abrasive media. The method may comprise preparing a melt composition. Melt compositions of various compositions may be prepared. One embodiment of the melt composition comprises 50 wt. % to 75 wt. % of silicon oxides, 12 wt. % to 40 wt. % of iron oxide, and 4 wt. % to 20 wt. % of at least one flux component. The melt composition may be referred to as a “glass batch.” The term “glass batch” may refer to the raw materials fed into a batch furnace or a continuous furnace.

Another embodiment of the melt composition comprises 50 wt. % to 75 wt. % of silica, 12 wt. % to 40 wt. % of iron containing material, 4 wt. % to 20 wt. % of at least one flux component. In embodiments, the iron containing material may be at least one of iron oxides, iron silicates, iron filings, or iron containing minerals. In such embodiments, the melt composition comprises 50 wt. % to 75 wt. % of silicon oxide, 10 wt. % to 40 wt. % of iron containing metal filings, and 4 wt. % to 20 wt. % of at least one flux component.

In some embodiments, the melt composition comprises or consists essentially of 40 wt. % to 80 wt. % of cullet and 8 wt. % to 60 wt. % of at least one metal oxide. In these embodiments, the metal oxide may be at least one of iron oxide, aluminum oxide, zirconium oxide, titanium oxide, magnesium oxide. The metal oxides may be added individually, in alloys, or minerals comprising these metal oxides. As used herein, the term “cullet” includes both process cullet and postconsumer cullet.

Further embodiments of the method of forming an amorphous silica product or abrasive comprise preparing a melt composition, wherein the melt composition comprises 50 wt. % to 75 wt. % of silica, 12 wt. % to 40 wt. % of a mix of metal oxides, and 2 wt. % to 20 wt. % of at least one flux component. In this embodiment, the silica may be amorphous silica (cullet, obsidian) or crystalline silica.

The methods may further comprise other glass manufacturing or frit manufacturing process steps, such as, but not limited to, melting the melt composition in a furnace to form a melt, cooling the melt to form a solid product, crushing or otherwise comminuting the amorphous product to form particles and/or classifying the particles into particle size ranges.

In any embodiment, the silicon oxides may include amorphous or crystalline silicon oxides in the melt composition. The silicon oxides may be cullet, sand, stone, gravel, or other silica containing minerals, for example.

The basic and novel features of the invention are to prepare an amorphous silica product or abrasive blasting media that does not comprise significant concentration of crystalline silica or other toxic compounds for use in industrial, commercial, or residential applications.

In some embodiments, the amorphous silica product may comprise significant amounts of deleterious toxic compounds or heavy metals if they do not cause industrial hygiene problems during manufacture, transport or use.

In another embodiment, the process for producing amorphous products consists essentially of heating sand and/or a mineral comprising crystalline silica into at least one amorphous mass, cooling or allowing the amorphous mass to cool, crushing or otherwise comminuting the size of the amorphous mass into gravel, sand, or silt sized particles, and classifying the sand, gravel, or silt sized particles into a desired particle size distribution for use as an abrasive blasting media or in other products.

In another embodiment, the process for producing amorphous products consists essentially of heating sand and/or a mineral comprising crystalline silica to a temperature between the melting temperature and less than the gob temperature of the glass batch, quenching, cooling or allowing the amorphous mass to cool, reducing the size of into gravel, sand, or silt sized particles, and grading the gravel, sand, or silt sized particles into a desired particle size distribution for use as an abrasive blasting media or in other products.

Embodiments of the method of the present invention may not require the post melt processing steps of glass making such as forming and floating, for example.

As such, embodiments of the method comprise preparing a glass batch comprising crystalline silica, heating the glass batch or melt composition to produce a molten amorphous mass in a furnace, cooling the furnace effluent such as by quenching the amorphous mass in a water bath or spray to produce amorphous silica mass or particles, optionally, further crushing the amorphous silica particles, and, optionally, annealing the amorphous silica particles.

The iron oxides or iron silicates, aluminum oxide or silicates, and/or the zirconium oxides or silicates, for example, may be added to the melt composition or glass batch in the form of various sources including clays and minerals.

The “amorphous sand” or other amorphous silica product could be formed directly into particles by fritting, for example, or formed into larger masses and crushed depending on the preferred method to obtain a commercially viable and advantageous product for various applications.

In certain embodiments, the properties of amorphous silica or sand may be improved for a specific application such as for use as a blasting media. Currently, there is no tailoring of recycled glass for blasting at this time. Since current amorphous silica blasting media was originally produced for a different purpose (container or plate glass), the properties have not been tailored as a blasting media. The amorphous silica blasting media could have the following properties, for example, if possible:

1) Specific gravity higher than crushed glass, for example, over 2.6 (crushed glass is approximately 2.5, crystalline silica sand is approximately 2.6); and 2) Hardness (mohs scale) approaching 7.0 to 7.5 (crushed glass is 5.5 to 7, crystalline silica sand is approximately 5 to 6) or a Knoop hardness above 520 or in certain embodiments above 680, for example.

At least one embodiment of the blasting media will be water soluble, so stabilizers such as calcium oxide, for example, are not required in certain embodiments as are typically added to the production of container glass and plate glass.

Typical particle sizes for blasting abrasives are in the range of mesh size 20/30, 30/70, and 50/100, for example. These mesh sizes may, typically, include 10% of the particles above or below the stated mesh size range.

Proppants may also be used and sold in various particle size ranges. The typically coarsest standard product for proppant is 20/40. (20/40 particle size means that 90 percent of the proppant product is small enough to pass through the 20 mesh screen having an opening of 0.85 mm) and large enough for greater than 90% of the particles to be retained on the 40 mesh screen (0.425 mm). Each product allows for a distribution of grain sizes within the range. Other standard proppant sizes are 30/50, 40/70, and 50/140 and are similarly defined. Embodiments of the proppants have particle sizes in the range of 20 to 140 mesh, further embodiments, include proppants having particles in the following particle size ranges 20/40, 30/50, 40/70, and 50/140. Further, embodiments of the method comprise melting the glass batch, crushing the amorphous solid, and classifying the particles in particle size range appropriate for use as a proppant. The particle size ranges appropriate for use as a proppant include, but are not limited to, 20/24, 30/50, 40/70, and 50/140, for example.

In further embodiments, appearance and opacity would not matter as much as in a blasting material as in container or plate glass. Embodiments of the amorphous silica products may not have any transparency or clarity restrictions. Constituents added to the batch to reach these properties may make the glass opaque, ugly or unable to be formed by traditional glass methods, for example.

Embodiments of the amorphous silica products should have no significant amounts of toxic components at sufficient quantities that would create inhalation hazards if used where human contact or inhalation is expected. Blasting media comprising iron oxides have shown low toxicity in testing. In contrast to the other abrasive blasting agents, for example, the major component of specular hematite is iron oxide and specular hematite produced no significant alterations in BAL levels of LDH, numbers of lung PMN, macrophage chemiluminescence, the amount of pulmonary hydroxyproline, or fibrotic score. (Barnes Environmental, Inc., 1996). These findings are consistent with the low toxicity of iron oxide in most rat studies (Stokinger, 1984). A recent study in humans also suggests that the initial inflammation associated with intrapulmonary instillation of iron oxide resolves rapidly after exposure (Lay et al., 1999).

The glass batch and/or crystalline silica sand or rock need only be converted to an amorphous silica, not fully melted. The cooling and crushing processes may be designed for economy, to deliver the desired properties, and to provide ease with the production of sand sized particles in the desired particle size ranges. Embodiments of the process to produce amorphous glass products may be summarized as an efficient method of producing crushed, recycled glass particles with higher density and improved hardness directly from crystalline silica materials for the same cost as recycle glass or from cullet to enhance the properties for specific applications.

The production of a relatively high iron amorphous mineraloid can be performed without more rigorous processes such as found in the production of soda lime glass. Embodiments of the method of forming the amorphous silica product may not require fining/viscosity reduction or annealing of container or flat glass.

As stated, the method may further comprise melting glass cullet in combination with property enhancing components. The property enhancing components may comprise iron oxides, iron silicates, iron, aluminum oxide, aluminum silicates, aluminum, zirconium oxide, zirconium silicates and/or other materials comprising zirconium to produce an enhanced amorphous silica product. The property enhancing components may provide an amorphous silica product with higher hardness and/or higher density that typical recycled glass or glass cullet.

In a typical glass process, the silica does not melt but is solubilized in the flux such as the melted sodium carbonate. Embodiments of the process include replacing at least a portion of the calcium oxide (or calcium carbonate) and the sodium carbonate in container glass with iron, aluminum or similar materials as fluxes. The iron can come from clays or iron oxides and the aluminum can come from aluminum oxide which is abundant and cheap. There are aluminum silicates that also include iron that may be added.

Embodiments of the method do not comprise or can eliminate the fining process step of container glass making and, further, may not need to completely melt the components as iron or other particles, bubbles, etc. are not detrimental to the product. Frit furnaces do not include a fining process, for example.

Embodiments of the invention change soda lime glass composition by changing fluxes to enhance density and hardness. Replacing sodium carbonate and calcium carbonate with oxides of iron and alumina, both of which make excellent fluxes, should make a glass oxide product that exhibits higher density and/or hardness than ordinary soda lime glass.

The glass batch and amorphous silica products are defined by their components. However, zirconia (zirconium oxide) may be replaced with zirconia silicate, for example, on a zirconia equivalent substitution. The same molar amount of zirconium silicate may be added to the glass batch or be present in the amorphous silica product to maintain the weight percentage of zirconium. Similarly, aluminum oxide may be substituted for alumina silicate and iron silicate may be substituted for iron oxide.

Components that may be added that do not materially affect the basic and novel characteristics of the claimed invention include, but are not limited to, do not materially affect the basic and novel characteristic(s)” of the claimed invention. The secondary, additive materials may include colorants, decolorants, fining agents, oxidizers, reducers, or any other additive that does not contribute to the main oxide content of the glass.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of components, parts, techniques and steps are disclosed. Each of these has individual benefit and each can also be used in conjunction with one or more, or in some cases, all of the other disclosed embodiments and techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### DESCRIPTION

Embodiments of the invention include abrasive blasting media, proppants, and other amorphous silica products. The other amorphous silica products include, but are not limited to, amorphous silica sands, gravels, or other particles, containers, sheets, or fibers, beads, spheres, and manufactured articles. The abrasive blasting media, proppants, and amorphous silica products may comprise amorphous silica and other components that result in products with properties that are beneficial for the intended application or to improve the processing of the material.

An embodiment of the method comprises heating granules, grains, or particles of sand, minerals, or rock comprising crystalline silica (hereinafter, “crystalline silica”) to a temperature where the crystalline silica loses its crystalline structure and is transformed into an amorphous silica or amorphous silicate. The amorphous silica is then cooled at a sufficient rate to prevent recrystallization and, therefore, produce an amorphous silica or silicate sand, gravel, or other particle, sheets, or fibers, beads, spheres, and manufactured articles.

Embodiments of the method comprise heating any type of sand or mineral comprising crystalline silica to a temperature in which the crystalline silica converts to amorphous silica form. The crystalline silica may be mixed with other components prior to or during the melting process such as, but not limited to, at least one of melting point reducing agents (fluxes), formers, stabilizers, density increasing components, hardness increasing components, toughness increasing components, or combinations thereof.

Another embodiment of the invention comprises adding additional components to an amorphous silica product, such as glass or cullet, to form a glass batch and melting the glass batch to incorporate the additional components into the amorphous silica. The additional components include, but are not limited to, at least one of a material comprising crystalline silica, melting point reducing agents (fluxes), formers, stabilizers, density increasing components, hardness increasing components, toughness increasing components, or combinations thereof. In one embodiment, the method comprises mixing recycled glass (cullet) to the crystalline silica sand or mineral and additional components to form the glass batch and melting the glass batch.

Embodiments of a method of producing an abrasive particle comprise melting a glass forming material with property improving components. Some of the property improving components include, but are not limited to, metals, metal oxides, metal silicates, fluxes, metal ores, sources of these components, and combinations thereof. These sources of the property improving components include, but are not limited to, ores such as, magnetite, lodestone, taconite, iron ores and products produced from iron ore, other minerals such as, but not limited to, limestone, garnet, furnace slags including, but not limited to, coal slags, iron slags, copper slags, nickel slags and other metal slags.

The metal oxides include iron oxides, FeO, FeO2, mixed oxides Fe(II, III), Fe3O4, Fe(III), and Fe2O3, aluminum oxides, zirconium oxides, intermediate glass forming oxides such as, but not limited to, alumina, zirconia, titania, ferric iron, glass modifier oxides such as, but not limited to, oxides of calcium, magnesium, zinc, ferrous iron, alkali metals and other glass forming oxides, intermediate glass forming oxides and glass modifier oxides apparent to a person skilled in the art are considered to be within the scope of the present invention. One particular source of iron oxide that may be used in embodiments of the invention is magnetite and Fe(II, III). Therefore, in one embodiment, the metal oxides may consist essentially of magnetite. In such embodiments, the magnetite may be added to the batch in concentration of 15 wt. % to 40 wt. % alone or in combination with other metal oxides. The source of the iron oxides may be iron ore.

The embodiments below are exemplified primarily with iron oxides, however, the iron oxides may be replaced with at least one of at least one of a metal oxide, a metal silicate, a metal, a metal silicide, or combination thereof. For example, the iron oxides may be replaced with a metal, metal oxides, or metal silicates including, but not limited to, be iron, iron oxides, iron silicates, aluminum oxides, aluminum silicates, aluminum, zirconium oxides, zirconium silicates, or zirconium, titanium oxides, combinations thereof, or ores or other sources containing these components.

Silicate glass precursors include raw materials such as, but not limited to, silica sand, glass cullet, recycled glass, siliceous materials and minerals, alumina, alumina silicate materials, boron oxide, borosilicates, calcium carbonates, calcium silicates, aluminates, alumina bearing materials, lime, and magnesium bearing materials, limestone, dolomite, and alkaline oxide bearing compounds and minerals such as phosphates, carbonates and hydroxides of alkali metals. The above list may not be exhaustive and any other materials apparent for the person skilled in the art are considered to be included within the scope of the present invention. For example, the limestone in the embodiments as described herein that is added to cullet, silica sand, concrete sand, or combination thereof may be substituted by or mixed with dolomite, sea shells, oyster shells, chalk, calcite, aragonite, glendonite, ikaite, calcium carbonate, amorphous calcium carbonate, synthetic calcium carbonate, or combinations thereof in the same concentration ranges.

Various embodiments of the methods produce abrasives, proppants or other products (amorphous silica particles) having a density greater than 2.5 g/ml or between 2.5 g/ml and 4.0 g/ml. In other embodiments, the abrasives, proppants or other products having a density between 2.5 g/ml and 3.5 g/ml. Further embodiments of the methods produce the amorphous silica particles have a density greater than 2.65 g/ml and 3.6 g/ml; a density greater than 2.80 g/ml and less than 4.0 g/ml; and amorphous silica particles have a density greater than 3.0 g/ml and less than 4.0 g/ml. Various applications of the particles may have different desired densities. The density of the particles may be tailored as desired by modifying the composition of the glass, the process parameters, or the post-production heat and pressure treatment, for example.

### Cullet 50-75/Iron Oxide

Batches may be based upon melting amorphous silica products with property enhancing components. For example, embodiments of the method of producing an abrasive particle may comprise preparing a batch comprising glass cullet in a concentration range of 50 wt. % to 75 wt. %; iron oxide in a concentration range of 20 wt. % to 40 wt. %; and fluxes in a concentration range of 5 wt. % to 40 wt. %. In any embodiment, the batch may be fed into a batch furnace or a continuous furnace. The batch materials may be premixed and fed into the furnace, fed individually or some components may be premixed, and some may be fed into the furnace individually. In a further embodiment, preparing a batch may consist essentially of glass cullet in a concentration range of 50 wt. % to 75 wt. %; iron oxide in a concentration range of 20 wt. % to 40 wt. %; and fluxes in a concentration range of 5 wt. % to 40 wt. %.

The batch may be melted in a furnace to produce furnace effluent or melt effluent. Typically, the batch components will be fed into the furnace as solids and flow out as a molten liquid. The melt effluent is, typically, a liquid melted glass that flows from the furnace exit. The melt effluent may be cooled to form a solid amorphous glass by any known means. The cooling means may include, but is not limited to, water quenching, oil quenching, air cooling, annealing, and controlled air cooling. Therefore, in any embodiment, a quenching step may be replaced with any other cooling step as described herein or known in the art. The glass effluent is merely cooled to form a solid. This may include floating or molding of the glass.

In one embodiment, the method comprises quenching the melt effluent to form amorphous silica particles or amorphous silica mass. The quenching may be performed by directing the furnace effluent into a water bath as known in the art.

For some applications, it may be desirable to have the amorphous silica particles or amorphous silica mass in different particle sizes. The method may further comprise crushing the amorphous silica particles to form particles of the appropriate size for the desired application by methods known in the art.

Additionally, The glass may undergo further densification process such as, but not limited to, heat treatments, cold compression, or hot compression. The densification may occur after quenching or after crushing the particles to the desired particle size range, particle size average or other distribution. Silica glasses may undergo reversible and irreversible amorphous-amorphous transitions under pressure, leading to some elastic softening upon initial compression and permanent densification under high pressure. At room temperatures (cold-compression), at pressures above 8-9 GPa, irreversible polyamorphic transition takes place and the recovered glass has an increased density. The same or even higher amount of densification can be achieved under much lower pressures (4-8 GPa) at high temperatures (hot-compression). Under hot or cold compression, the silica glass may densify up to about 25%.

In some embodiments, the method may comprise adding a combustible material to any of the batches described herein. The combustible material may be any combustible material that undergo combustion at a temperature below the melt temperature of the batch or the processing temperature. For example, combustible materials include organic matter, cellulosic material, plastics, paper, cloth, natural gas, oils, wood, charcoal, coke, coal, fuels, and combinations thereof.

The combustible material may be added separately or in combination with other components of the batch. For example, charcoal or coke particles or powders may be premixed in the batch with the other components or be present in one of the components of the batch. For example, recycled glass products may comprise combustible materials such as, but not limited to, paper, plastics, cardboard, oils, food residues, for example, and may, therefore, may be added to the batch with the recycled glass.

The combustible material may be added to the batch in any desired concentration range, for example, the combustible material may be in a concentration range of above 0 wt. % to 25 wt. %. The combustible material in the batch appears to act to increase the density of the amorphous silica particles. In other embodiments, the combustible material may be added to the batch in a concentration range of above 0.2 wt. % to 20 wt. %. In still further embodiments, the combustible material may be added to the batch in a concentration range of above 0.2 wt. % to 15 wt. %. In more specific embodiments, the combustible material may be added to the batch in a concentration range of above 0.5 wt. % to 8 wt. %.

Limestone and its substitutes have been shown to increase the density of some embodiments of the amorphous silica products. Limestone additions to the batch have also resulted in other improved properties of the amorphous silica particles. Embodiments of the batch comprise limestone in concentration of 1 wt. % to 50 wt. %. In further embodiments, the limestone may be added to the batch in a concentration of 10 wt. % to 40 wt. %. In some embodiments, the batch may benefit from high concentrations of limestone, thus in such embodiments, the limestone may be incorporated in the batch in a concentration of 25 wt. % to 40 wt. %. Limestone may be substituted with other sources of calcium equivalent concentrations of calcium carbonate or calcium oxides as described. In a particularly interesting embodiment, the batch comprises limestone in a concentration range of 25 wt. % to 40 wt. % and iron oxide, iron ore, or a combination thereof in a concentration range of 25 wt. % to 40 wt. %. The remainder of the batch includes cullet, sand and a combination of fluxes.

In a particular embodiment, the batch consists essentially of cullet in a concentration range of 15 wt. % to 30 wt. %; limestone in a concentration range of 25 wt. % to 40 wt. %; iron oxide, iron ore, or a combination thereof in a concentration range of 25 wt. % to 40 wt. % and fluxes in a range of 0 wt. % to 15 wt. %. Such embodiments of the batch after melting and cooling may produce amorphous silica particles have a density greater than 2.65 g/ml and 3.6 g/ml and in some embodiments, a density greater than 2.80 g/ml and less than 4.0 g/ml. In embodiments wherein the batch consists essentially of cullet in a concentration range of 15 wt. % to 30 wt. %; limestone in a concentration range of 30 wt. % to 40 wt. %; iron oxide, iron ore, or a combination thereof in a concentration range of 30 wt. % to 40 wt. % and fluxes in a range of 0 wt. % to 15 wt. %, the amorphous silica particles produces after melting and cooling may have a density greater than 3.0 g/ml and less than 4.0 g/ml.

Additionally, iron ores may be added to the batch as a source of iron compounds to produce the amorphous silica products. In a particular embodiment, a method of producing an abrasive particle from iron ore, the method comprises preparing a batch comprising of glass cullet in a concentration of 50 wt. % to 70 wt. %, iron ore in a concentration of 20 wt. % to 60 wt. %, and fluxes in a concentration of 5 wt. % to 40 wt. %. The batch may be melted to form a melt effluent and then be cooled to form an amorphous silica particle. Additionally, the method of producing an abrasive particle from iron ore, the method consists essentially of preparing a batch comprising of glass cullet in a concentration of 50 wt. % to 70 wt. %, iron ore in a concentration of 20 wt. % to 60 wt. %, and fluxes in a concentration of 5 wt. % to 40 wt. %. The iron ore in the batch may comprise taconite, wherein the taconite in a concentration of 20 wt. % to 35 wt. %. In other embodiments, the iron ore may consist essentially of taconite.

In some cases, other metal ores may be added into the glass batch with either crystalline silica, amorphous silica or a combination thereof. Ores such as, but not limited to, iron ore, taconite, or bauxite may be added, for example. The addition of bauxite to the glass batch may comprise adding a combination of the crystalline silica, iron oxides, and additional metal oxides such as aluminum oxide with the one component.

The addition of the combustible material may further improve the properties of the amorphous silica particles. The mechanism is not fully understood at this time but the results have been confirmed by significant experimentation. Any of the embodiments described herein may also comprise a combustible material in the batch in any concentration capable of improving the properties of the amorphous silica production. For example, a method of producing an abrasive particle comprising preparing a batch comprising glass cullet in a concentration range of 50 wt. % to 75 wt. %, iron oxide in a concentration range of 20 wt. % to 40 wt. %, and a combustible material that ignites at a temperature less than the melt temperature of the batch in a concentration range of 0.5 wt. % to 25 wt. %. The method may further comprise melting the batch in a furnace to melt effluent, quenching the melt effluent to form amorphous silica particles or mass, and crushing the amorphous silica particles or mass to form abrasive particles. The combustible materials may be any material that may be intermixed with the other components of the batch. Examples have been previously described.

A further embodiment includes a batch that comprises a combustible material and limestone. The combination of a combustible material and limestone appears to provide a synergism that results in a higher density amorphous silica product than either component alone. For example, the batch may comprise combustible materials in the concentration range of 0.5 wt. % to 25 wt. %. and limestone in a concentration range of 10 wt. % to 40 wt. % with any other disclosed components including the amorphous or crystalline silica material.

The limestone and the combustible material in combination at melt temperatures contribute to a produce amorphous silica particles and other products with an increased density. Such embodiments of the batch after melting and cooling may produce amorphous silica particles have a density greater than 2.65 g/ml and 3.6 g/ml and in some embodiments, a density greater than 2.80 g/ml and less than 4.0 g/ml. In embodiments wherein the batch consists essentially of cullet, sand or a combination of cullet and sand in a concentration of 5 wt. % to 20 wt. %, limestone in a concentration range of 25 wt. % to 40 wt. %; iron oxide, iron ore, or a combination thereof in a concentration range of 30 wt. % to 40 wt. %, combustible material in a concentration of 2 wt. % to 12 wt. % and fluxes in a range of 0 wt. % to 15 wt. %, the amorphous silica particles produces after melting and cooling may have a density greater than 3.0 g/ml and less than 4.0 g/ml. In some embodiments, the limestone may be in concentration range of 25 wt. % to 40 wt. %. The fluxes may comprise or, in some embodiments, consist essentially of, at least one of sodium carbonate and potassium carbonate.

Further, embodiments of the method comprise adding a combination of limestone and iron oxide, iron ore or combination thereof to a glass cullet. The limestone and iron oxides may be combined with the amorphous and/or crystalline silica in any concentration that produces a higher density amorphous silica product after melting and cooling together. For example, an embodiment of the method of producing an abrasive particle comprises preparing a batch comprising glass cullet in a concentration range of 20 wt. % to 55 wt. %, at least one of iron oxide and iron ore in a concentration range of 20 wt. % to 55 wt. %, and limestone in a concentration range of 8.0 wt. % to 40 wt. %. The batch may be further processed as described for other embodiment to produce an amorphous silica particle, abrasive particles or other amorphous silica product as described herein. Such batches may further comprise a combustible material. The combustible material may be in the concentration range of 1 wt. % to 15 wt. %, for example. It may be advantages to add a recycled glass cullet that includes other recycled combustible products. In such a case, the recycled glass may not have to be cleaned to a degree required by other uses of recycled glass cullet processes such as, but not limited to, container or float glass production.

In such embodiments, limiting the limestone concentration to a higher range may produce an amorphous silica particle with improved properties for certain applications. Therefore, an embodiment of the method of producing an abrasive particle comprises preparing a batch comprising glass cullet in a concentration range of 20 wt. % to 55 wt. %, at least one of iron oxide and iron ore in a concentration range of 20 wt. % to 55 wt. %, and limestone in a concentration range of 25 wt. % to 40 wt. %. In other embodiments, the limestone may in a concentration range from 25 wt. % to 35 wt. %. Further, to adjust melt temperatures or viscosity of the melt effluent (as in other embodiments) the batch may comprise fluxes in the range of 0.5 wt. % to 20 wt. %. In such embodiments, the fluxes may consist essentially of at least one of sodium carbonate and potassium carbonate.

In a still further embodiment, the method of producing an abrasive particle, comprising preparing a batch consisting essentially of glass cullet in a concentration range of 20 wt. % to 55 wt. %, at least one of iron oxide or iron ore in a concentration range of 20 wt. % to 55 wt. %; and limestone in a concentration range of 8.0 wt. % to 40 wt. %, melting the batch in a furnace to produce a melt effluent. In a still further embodiment of the method combining the glass cullet, limestone and iron, the method consists essentially of preparing a batch comprising glass cullet in a concentration range of 20 wt. % to 55 wt. %, at least one of iron oxide and iron ore in a concentration range of 20 wt. % to 55 wt. %, limestone in a concentration range of 20 wt. % to 40 wt. %, and fluxes in a concentration range of 1 wt. % to 15 wt. %, for example.

In these embodiments, the glass cullet may be substitute either completely or partially with silica sand or other silica containing material on a molar equivalent amount of silicon. If the glass cullet is either partially or completely replaced with silica sand or other silica containing material, the amount of flux may be increased to compensate for the flux that was not added with the glass cullet. In some embodiments, the upper range of the flux concentration range may be increased to compensate for this “missing” flux.

Embodiments of the invention may comprise adding iron ore or other material comprising iron compounds into the batch prior to melting. Thus, further embodiments for a method of producing an abrasive product include preparing a batch from silica sand, at least one of iron oxide, iron ore, and other iron containing minerals or materials and limestone. The melt temperature and the viscosity of the furnace effluent (melt effluent) may be adjusted with the addition of fluxes as described herein.

In one embodiment, the method of producing an abrasive particle comprises preparing a batch comprising silica sand, a combination of iron oxides, iron ore or a combination thereof in a range of 20 wt. % to 55 wt. %, and limestone in a concentration range of 25 wt. % to 45 wt. %. In some embodiments, the combination of iron oxide, iron ore or a combination thereof and limestone or other source of calcium is in a range of from 40 wt. % to 80 wt. %.

As such, methods of preparing a batch comprising silica sand in a concentration range of 5 wt. % to 25 wt. %, at least one of iron oxide or iron ore in a concentration range of 20 wt. % to 55 wt. %, and limestone in a concentration range of 25 wt. % to 45 wt. %. The method further comprises melting the batch in a furnace to melt effluent and cooling the melt effluent to form amorphous silica particles or mass and crushing the amorphous silica particles or mass to form abrasive particles. In some more specific embodiment, the silica sand of this batch may be in a concentration range of 8 wt. % to 18 wt. %.

In some embodiments, the batch comprising silica sand, a combination of iron oxides, iron ore or a combination thereof in a range of 20 wt. % to 55 wt. %, and limestone in a concentration range of 25 wt. % to 45 wt. %. may additionally comprise glass cullet. For example, a batch in this embodiment may comprise glass cullet in a concentration range of 0.5 wt. % to 10 wt. % or in a more specific embodiment, the batch comprises glass cullet in a concentration range of 2.0 wt. % to 8.0 wt. %.

Similar to all other embodiments, the batch may comprise iron oxide in a concentration range of 20 wt. % to 40 wt. % and the iron oxide may consist essentially of magnetite.

Also, the batch comprising silica sand, a combination of iron oxides, iron ore or a combination thereof in a range of 20 wt. % to 55 wt. %, and limestone in a concentration range of 25 wt. % to 45 wt. %. may additionally comprise glass cullet (as described above), fluxes, and/or a combustible material. These embodiments of the method may comprise combustible materials in a concentration range of 1 wt. % to 15 wt. %.

Mineral slags comprise silica compounds and other metal oxides and, therefore, they may be used in embodiments of the methods. Such slags may comprise components above acceptable limits by industrial hygiene organizations. In embodiments of the invention, glass cullet, sand, and/or additional oxides such as, iron oxide, aluminum oxide, titanium oxide and zirconium oxide, for example, may be added to the batch to produce an amorphous silica product having the potentially toxic components below the acceptable limits. Mineral slag including, but not limited to, iron slag, nickel slag, copper slag, platinum slag, and coal slag, may also be blended into a batch to produce an amorphous silica product. The mineral slags may be combined with any of the components as described herein including, but not limited to, silica sand, glass cullet, iron ore or iron oxides, limestone, combustible materials, fluxes, and/or the substitutes for these materials as described herein.

Thus, further embodiments of the method of producing an abrasive particle may comprise preparing a batch comprising at least one mineral slag in a concentration range of 40 wt. % to 70 wt. %, glass cullet in a concentration range of 5 wt. % to 25 wt. %, at least one of iron oxide or iron ore in a concentration range of 10 wt. % to 35 wt. %, and limestone in a concentration range of 0 wt. % to 15 wt. %. The batch may be melted and further processed as described herein. The glass cullet may be added in different concentrations to vary the manufacturing costs, density and hardness. As such, the glass cullet may be in a concentration range of 8 wt. % to 18 wt. %. or the glass cullet may be in a concentration range of 10 wt. % to 20 wt. %. As in other embodiments, the batch may comprise fluxes in the range of 0.5 wt. % to 20 wt. %. These embodiments may produce amorphous glass products having a specific gravity of greater than 2.8 g/ml or a specific gravity of greater than 3.0 g/ml and less than 4.0 g/ml. The batches comprising mineral slags may also comprise the any of the components described herein.

Preparing the Glass Batch, Batch, or Melt Composition

Embodiments of the method comprise preparing a glass batch. There are three general composition classifications of the glass batches; glass batches based upon crystalline silica primarily such as sands and crystalline silica minerals, glass batches based upon amorphous silica or cullet primarily such as glass cullet or recycled glass, and glass batches based upon a combination of crystalline silica and amorphous silica. The crystalline silica may be obtained from minerals and sands, such as quartz, cristobalite and tridymite.

Crystalline Silica Glass Batches

The crystalline silica may be mixed with additional components, such as, but not limited to, melting point reducing agents (fluxes), glass formers, stabilizers, density increasing or decreasing components, hardness increasing or decreasing components, toughness increasing components, or combinations thereof, for example.

The melting point of crystalline silica is high, about 1710° C. (3110° F.). Without special equipment such as induction furnaces and specialty materials, it is difficult to directly convert crystalline silica to amorphous silica. However, the melting point may be reduced by addition of at least one melting point reducing agent (flux). In some embodiments, preparing a glass batch comprises mixing the crystalline silica containing material with at least one melting point reducing agent. Reducing the melting point of the glass batch may result in a more efficient process that requires less energy to convert the crystalline silica to amorphous silica. Melting point reducing agents are compounds or elements that lower the temperature or temperature range that the crystalline silica is converted to amorphous silica or melts first and solubilizes the crystalline silica.

In one embodiment, the glass batch may comprise, or consist essentially, of crystalline silica and at least one a metal, a metal oxide or a metal silicate. For example, in one embodiment, the glass batch may comprise, or consist essentially of, crystalline silica in the range of 50 wt. % to 75 wt. % and at least one of iron oxides or iron silicates in the range of 20 wt. % to 45 wt. %. The iron oxide acts as both a flux for the glass batch and to increase the density of the amorphous silica product above the density of a pure amorphous silica or, in some embodiments, above the density of container glass. To further reduce the melting point of the glass batch, the glass batch may comprise additional fluxes. The additional fluxes may be in a range of 0 wt. % to 25 wt. %, for example, or in the range of 0 wt. % to 12 wt. % in other embodiments.

In an embodiment, the glass batch consists essentially of crystalline silica in the range of 50 wt. % to 75 wt. %, at least one of iron oxides or iron silicates in the range of 20 wt. % to 45 wt. %, and additional fluxes may be in a range of 2 wt. % to 25 wt. %.

A further embodiment of the method comprises preparing a glass batch consisting essentially of crystalline silica, a combination of iron oxides and calcium compounds in a concentration from 50 wt. % to 80 wt. % and fluxes in a concentration range of 2 wt. % to 20 wt. %. In such an embodiment, individually the iron oxides and the calcium compounds may be in a concentration range of 25 wt. % to 40 wt. %. In such embodiments, the iron oxide may be magnetite and the calcium compounds may be limestone. A still further embodiment of the method comprises preparing a glass batch consisting essentially of crystalline silica, a combination of iron oxides and calcium compounds in a concentration from 50 wt. % to 80 wt. %; fluxes in a concentration range of 2 wt. % to 20 wt. %, and a combustible material. The combustible material may be in a concentration range of 0.5 wt. % to 15 wt. %.

Other embodiments of the method consist essentially of preparing a glass batch consisting of mineral slags, sand, iron oxide, calcium compounds, and fluxes. As in other embodiments, the fluxes may be in a concentration sufficient to lower the melt temperature and lower the viscosity of the melt effluent as desired, such as in a concentration range of 0 wt. % to 15 wt. %, for example. The mineral slags may be in a concentration range of from 30 wt. % to 60 wt. %, for example. The concentration of mineral slag may be determined by the dilution factor needed to lower the concentration of any toxic components below hazardous levels as determined by indu In some such embodiments, a combination of iron oxides and calcium compounds in a concentration from 50 wt. % to 80 wt. % in total. In such an embodiment, individually the iron oxides and the calcium compounds may be in a concentration range of 25 wt. % to 40 wt. %. In such embodiments, the iron oxide may be magnetite and the calcium compounds may be limestone.

For some applications, the glass batch may comprise higher concentrations of iron oxides. In another embodiment, the glass batch may comprise crystalline silica in the range of 50 wt. % to 70 wt. % and at least one of iron oxides and iron silicates in the range of 30 wt. % to 50 wt. %. Again, to further reduce the melting point of the glass batch, the glass batch may further comprise additional fluxes. The additional fluxes may be in a range of 0 wt. % to 25 wt. %, for example, or in the range of 0 wt. % to 10 wt. % in other embodiments. In an embodiment, the glass batch consists essentially of crystalline silica in the range of 50 wt. % to 70 wt. %, at least one of iron oxides or iron silicates in the range of 30 wt. % to 50 wt. %, and additional fluxes may be in a range of 2 wt. % to 25 wt. %.

The composition of the amorphous silica product will be directly related to concentrations of the glass batch except the crystalline silica will be in a predominantly amorphous state. The other components may also be amorphous and reported as oxides.

In another embodiment, the glass batch may comprise crystalline silica in the range of 50 wt. % to 70 wt. %, metal oxides or metal silicates in the range of 30 wt. % to 50 wt. %, and additional fluxes in the range of 0 wt. % to 25 wt. %. In another embodiment, the glass batch may comprise crystalline silica in the range of 40 wt. % to 60 wt. %, metals or metal oxides or metal silicates in the range of 30 wt. % to 60 wt. %, and additional fluxes in the range of 2 wt. % to 25 wt. %. In some cases, the metal oxides may be a combination of iron oxides with other metals or metal oxides to alter the properties of the amorphous silica product. For example, the metal oxides may be aluminum oxides, zirconium oxides, a combination of aluminum oxides and iron oxides, a combination of zirconium oxides and iron oxides, or a combination of aluminum oxides, zirconium oxides, and iron oxides. Similarly, in some cases, the metal silicates may be a combination of iron silicates with other metals or metal silicates to alter the properties of the amorphous silica products. In some embodiments, the aluminum oxides or aluminum silicates may be present in a range from 0.5 wt. % to 10 wt. %. In some embodiments, the zirconium oxides or silicates may be present in a range of from 0.5 wt. % to 10 wt. %. In some additional embodiments, a combination of aluminum oxides and/or silicates and zirconium oxides and/or silicates may be present in a range of from 0.5 wt. % to 10.

In one embodiment, the glass batch may comprise silicon oxide (amorphous or crystalline) in the range of 50 wt. % to 70 wt. %, iron oxides or iron silicates in the range of 27 wt. % to 47 wt. %; and fluxing compounds in the range of 2 to 15 wt. %. In a similar embodiment, the glass batch may consist essentially of silicon oxide in the range of 50 wt. % to 70 wt. %, iron oxides or iron silicates in the range of 27 wt. % to 47 wt. %; and fluxing compounds in the range of 2 to 15 wt. %.

Such embodiments will result in an amorphous silica product comprising silicon oxide in the range of 50 wt. % to 70 wt. % and iron oxides in the range of 27 wt. % to 47 wt. %. Other embodiments of the amorphous silica product or abrasive blasting media will consist essentially of silicon oxide in the range of 50 wt. % to 70 wt. %, iron oxides in the range of 27 wt. % to 47 wt. %, and fluxing compounds in the range of 2 to 15 wt. %.

Amorphous Silica Glass Batch

In one embodiment, the glass batch may comprise or consist essentially of amorphous silica and at least one metal or at least one metal oxide. For example, in one embodiment, the glass batch may comprise amorphous silica in the range of 40 wt. % to 75 wt. % and metal, metal silicates, and/or metal oxides in the range of 20 wt. % to 45 wt. %. In some embodiments, the metal, metal silicates, or metal oxides may be iron oxides, iron silicates, zirconium oxides, zirconium silicates, aluminum oxides, aluminum silicates, or combinations thereof. The other metals and metal oxides described herein may be components of other embodiments of the glass batches.

As in the crystalline silica glass batch, the iron oxide or iron silicates acts as both a flux for the glass batch and to increase the density of the amorphous silica product above the density of a pure amorphous silica. To further reduce the melting point of the glass batch, the glass batch may further comprise additional fluxes. The additional fluxes may be in a range of 0 wt. % to 25 wt. %, for example, or in the range of 0 wt. % to 10 wt. % in other embodiments.

Amorphous silica may be added to the glass batch from various sources. The sources of the amorphous silica may be glass cullet, recycled glass, unprocessed glass waste, partially processed glass waste, diatomaceous earth, or combinations thereof. Glass cullet, recycled glass and other glass waste comprise amorphous silica and other components including fluxes, stabilizers, formers, and colorants, for example. Therefore, the glass batch composition may account for the additional components in the source of the amorphous silica. For example, cullet may comprise fluxes in the range of 10 wt. % to 20 wt. %. If the glass batch comprises 60% glass cullet, the amount of flux added into the glass batch with the cullet will be between 6 wt. % and 12 wt %.

For some applications, the glass batch may comprise higher concentrations of metals, metal silicates, or metal oxides. In another embodiment, the glass batch may comprise amorphous silica in the range of 40 wt. % to 70 wt. % and iron oxides in the range of 30 wt. % to 50 wt. %. Again, to further reduce the melting point of the glass batch, the glass batch may further comprise additional fluxes. The additional fluxes may be in a range of 0 wt. % to 18 wt. %, for example, or in the range of 0 wt. % to 10 wt. % in other embodiments. In an embodiment, the glass batch consists essentially of crystalline silica in the range of 50 wt. % to 70 wt. %, iron oxides in the range of 30 wt. % to 50 wt. %, and additional fluxes may be in a range of 2 wt. % to 20 wt. %.

In another embodiment, the glass batch may comprise a silica in the range of 50 wt. % to 70 wt. %, metals, metal silicates, and/or metal oxides in the range of 30 wt. % to 50 wt. %, and additional fluxes in the range of 0 wt. % to 25 wt. %. In one embodiment, the metals, metal silicates, or metal oxides are iron, iron silicates, or iron oxides. In some additional cases, the metal oxides may be a combination of iron oxides with other metals or metal oxides to alter the properties of the amorphous silica product. For example, the metal oxides may be aluminum oxides, zirconium oxides, a combination of aluminum oxides and iron oxides, a combination of zirconium oxides and iron oxides, or a combination of aluminum oxides, zirconium oxides, and iron oxides. In some embodiments, the aluminum oxides may be present in a range from 0.5 wt. % to 12 wt. %. In some embodiments, the zirconium oxides may be present in a range of from 0.5 wt. % to 12 wt. %. In some additional embodiments, a combination of aluminum oxides and zirconium oxides may be present in a range of from 0.5 wt. % to 10. At least a portion of the metal oxides may be substituted with metal silicates, for example.

As such an embodiment of the amorphous silica product produced from amorphous sources of silica comprise amorphous silicon oxide in the range of 50 wt. % to 75 wt. %, a combination of iron oxides and aluminum oxides, wherein the iron oxides and the aluminum oxides together are in in the range of 15 wt. % to 50 wt. %, wherein the aluminum oxides are in a range of 0.5 wt. % to 10 wt. %., and fluxing compounds in the range of 0 to 10 wt. %. In a more specific embodiment, the aluminum oxides may be in the range of 3 to 10 wt. %.

Similarly, an embodiment of the amorphous silica product comprises amorphous silicon oxide in the range of 50 wt. % to 75 wt. %, a combination of iron oxides and zirconium oxides, wherein the iron oxides and the zirconium oxides together are in in the range of 12 wt. % to 50 wt. %, wherein the zirconium oxides are in a range of 0.5 wt. % to 10 wt. %., and fluxing compounds in the range of 0 to 10 wt. %. In a more specific embodiment, the aluminum oxides may be in the range of 0.5 wt. % to 5 wt. %.

In either of the above embodiments, the zirconium oxides or the aluminum oxides may be substituted with a combination of aluminum oxides and zirconium oxides.

Combinations of Amorphous Silica and Crystalline Silica

In some embodiments, the silica in the glass batch may be a combination of crystalline silica and amorphous silica. In any of the above embodiments, the crystalline silica or the amorphous silica in the glass batch may be replaced with a combination of amorphous silica and crystalline silica in the stated compositional ranges. For example, the glass batch may comprise sand and glass cullet. In other cases, the crystalline silica may be from a crystalline silica mineral, such as the addition of bauxite to the glass batch comprising cullet, the mineral, bauxite for example, may comprise a combination of the crystalline silica, iron oxides, and additional fluxes such as aluminum oxide.

By processing the glass batches in either glass manufacturing methods or frit manufacturing methods, amorphous glass products will be produced. The amorphous glass may be used for any purpose including, but not limited to, abrasive blasting media, proppants, high density amorphous glass product, and other products. Further embodiments of preparing a glass batch may include mixing the crystalline silica sand with recycled glass and/or cullet, if desired.

Heating the Glass Batch to Produce Amorphous Silica Products

Embodiments of the method comprise converting crystalline silica into an amorphous silica produce amorphous silica sand, gravel, or other particles, sheets, or fibers. The method may comprise heating the glass batch comprising crystalline silica to a temperature above the temperature that results in the phase change from the crystalline silica to an amorphous form of silica. The furnace may increase the temperature of the glass batch above the melting temperature of crystalline silica. The melting point of pure silica dioxide is 3110° F. (1710° C.) but may be lowered by addition of fluxes as described above.

Embodiments of the heating the glass batch comprise feeding the glass batch into a glass melting furnace. The furnace may be a continuous or batch furnace. There are various types of glass melting furnaces including pot furnaces (for batch processing), day tank furnaces, gas fired furnaces, and electric furnaces.

In an embodiment comprising a continuous furnace, the glass batch may be heated to and become molten at approximately 1100° C. to 1700° C., more specifically a temperature range 1300° C. to 1600° C., depending upon the composition of the glass batch. In some embodiments of the method, the glass batch may be heated to or above the melt temperature of the glass batch. In another embodiment, the glass batch may be heated to a temperature between the melt temperature and the temperature in which the crystalline silica converts to amorphous silica. As previously described, the melt temperature and the temperature at which the crystalline silica converts to amorphous silica will depend on the composition of the glass batch. In such embodiments, the glass batch may be heated to a temperature below the gob temperature. In certain batch embodiments, the glass batch may be heated to similar temperatures. In certain embodiments, the process does not comprise refining the molten glass batch to remove all gas bubbles. This process is necessary to produce clear glass containers or plate glass but may not be necessary to produce amorphous silica sand, gravel, and other particles, sheets, or fibers.

Alternatively, a further embodiment of the process comprises heating granules, grains, or particles of sand or rock comprising crystalline silica individually in combination with the other steps described herein. In further embodiments, the furnace may be a rotating kiln furnace.

The effluent of the furnace may be a ribbon of molten amorphous silica.

Cooling the Furnace Effluent

Embodiments of the method of the invention comprise cooling the ribbon effluent from the furnace. Therefore, a method may comprise cooling or allowing the amorphous mass cool to a hardened state. In some embodiments, the process may comprise rapidly cooling or quenching the ribbon of furnace effluent such as by fritting. Fritting of the molten glass causes a thermal gradient and violent fracturing of the solidifying amorphous material. The quenching of the molten glass may be performed by contact with a fluid such as water. The molten glass ribbon may overflow the furnace into a bath of fluid or the fluid may be spraying of the molten glass.

The solidified solid is an amorphous silica product. The fracturing of the glass results in small particles that may be classified into particle size ranges. The various particle size ranges may find application in the products described herein.

Embodiments of the method may further comprise crushing or otherwise comminuting at least a portion of the amorphous silica to particles to a smaller size or to narrow the particle size distribution. The desired particle size distribution may be the appropriate particle size distribution for abrasive blasting, use in mortar, plaster, concrete, and asphalt paving, foundry sand, and/or the production of bricks, for example.

Optionally, an embodiment of the process may comprise annealing fractured amorphous silica particle or the crushed or otherwise comminuted amorphous mass.

The molten glass batch exits the refractory through a weir. The weir is designed to provide an evenly shaped flow of molten glass for quenching. The furnace may have more than one weir to ensure proper molten glass ribbon shape and size for efficient quenching and fracturing of the solidifying amorphous silica.

In certain embodiments, quenching the molten amorphous mass should be performed properly to ensure fracturing of the amorphous solid upon rapid cooling. Ideally, the quenched amorphous solid comprises a particulate product having a desired particle size range, average particle size, and/or particle size distribution. The furnace effluent flow rate and shape may be controlled to provide uniform quenching of the amorphous silica.

Applications and Products

An embodiment of a process consists essentially of transforming crystalline or polycrystalline sand, grains, particles, or rock into amorphous sand, gravel or other particles for the purpose of rendering the material substantially free of crystalline silica (a known carcinogen) making it a safe replacement for naturally occurring products containing various forms of crystalline silica in consumer and industrial applications through a process comprising heating the crystalline or polycrystalline sand, grains, particles or rock into an amorphous mass and reducing the size of the amorphous mass for use in the desired application.

Still further embodiments of the process may comprise using amorphous sand for applications that currently of previously used crystalline or polycrystalline sand products including, but not limited to silica sand product applications and crushed rock products.

The amorphous sand and articles produced by this process are especially useful for processes that produce airborne dust such as for abrasive blasting or products that will be cut such as cement blocks, pavers, or bricks to avoid producing a potentially dangerous dust if crystalline silica sand was used, or are useful in recycling, repurposing, or otherwise transforming materials that might other wise be destined to landfills into products of value.

Products and applications for the amorphous silica particles include but are not limited to, crystalline silica free amorphous silica sand, crystalline silica free amorphous silica gravel, crystalline silica free amorphous cullet or feedstock, amorphous silica blasting material, crystalline silica free concrete, grout, manufactured stone, pavers, or mortar, concrete blocks made from crystalline silica free concrete, crystalline silica free bricks comprising crystalline free amorphous silica, crystalline silica free glass sheets, and crystalline silica free glass fibers. For example, the bricks may comprise crystalline silica free sand in a concentration from 50% to 60% by weight, alumina in a concentration from 20% to 30% by weight, and lime in a concentration from 2 to 5% by weight.

As such, an embodiment of the amorphous silica product comprises amorphous silicon oxide in the range of 50 wt. % to 75 wt. %, a combination of iron oxides and aluminum oxides, wherein the iron oxides and the aluminum oxides together are in in the range of 15 wt. % to 50 wt. %, wherein the aluminum oxides are in a range of 0.5 wt. % to 10 wt. %., and fluxing compounds in the range of 0 to 10 wt. %. In a more specific embodiment, the aluminum oxides may be in the range of 3 to 10 wt. %.

Similarly, an embodiment of the amorphous silica product comprises amorphous silicon oxide in the range of 50 wt. % to 75 wt. %, a combination of iron oxides and zirconium oxides, wherein the iron oxides and the zirconium oxides together are in in the range of 12 wt. % to 50 wt. %, wherein the zirconium oxides are in a range of 0.5 wt. % to 10 wt. %., and fluxing compounds in the range of 0 to 10 wt. %. In a more specific embodiment, the aluminum oxides may be in the range of 0.5 wt. % to 5 wt. %. In either of the above embodiments, the zirconium oxides or the aluminum oxides may be substituted with a combination of aluminum oxides and zirconium oxides.

Other embodiments of the amorphous silica product comprises unusually low levels of silicon in the form of amorphous silicon oxide in the range of 13 wt. % to 25 wt %, iron oxides in the range of 0% wt. % to 40 wt. %, Aluminum oxides in the range of 0 wt. % to 12 wt. %, magnesium oxides in the range of 0 wt. % to 3 wt. %, calcium oxides in the range of 8 wt. % to 25 wt %., alkali metals in the range of 0 wt. % to 1 wt. %, and carbon in the range of 0 wt. % to 10 wt. %. Such products exhibit excellent levels of density, often above 3.0 g/cm3, and favorable hardness for their applications, often in excess of 640 Knoop Hardness.

Limestone or other calcium glass formers may be added to the glass batch. As such, an embodiment of the amorphous silica product comprises amorphous silicon oxide in the range of 10 wt. % to 60 wt. %, a combination of iron oxides and calcium oxides, wherein the iron oxides and the calcium oxides together are in in the range of 15 wt. % to 85 wt. %, and fluxing compounds in the range of 0 to 20 wt. %. In a more specific embodiment, the iron oxides may be in the range of 30 to 45 wt. %. In such embodiments, the iron oxides may be in a concentration range of 10 wt. % to 60 wt. %. In another embodiment, the iron oxides may be in a concentration range of 20 wt. % to 50 wt. % and the calcium oxides may be in a concentration range of 10 wt. % to 40 wt. %. In a further embodiment, the iron oxides may be in a concentration range of 20 wt. % to 40 wt. % and the calcium oxides may be in a range of 20 wt. % to 40 wt. %.

Further, an embodiment of the amorphous silica product consists essentially of amorphous silicon oxide in the range of 10 wt. % to 60 wt. %, a combination of iron oxides and calcium oxides, wherein the iron oxides and the calcium oxides together are in in the range of 15 wt. % to 85 wt. %, and fluxing compounds in the range of 0 to 20 wt. %. In another such embodiments, the iron oxides may be in a concentration range of 10 wt. % to 60 wt. %. In another embodiment, the iron oxides may be in a concentration range of 20 wt. % to 50 wt. % and the calcium oxides may be in a concentration range of 10 wt. % to 45 wt. %. In a further embodiment, the iron oxides may be in a concentration range of 20 wt. % to 40 wt. % and the calcium oxides may be in a range of 20 wt. % to 40 wt. %. The amorphous silica of the invention may be used as water insoluble or water soluble sand and blasting media. In a more specific embodiment, the iron oxides may be in the range of 25 to 40 wt. %.

Unlike recycled glass products, the amorphous silica sand produced by the method of the invention will comprise no non-glass residues (trash or contaminants) such as trace fecal matter, trace ferrous items or matter (unless intentionally added), trace nonferrous items or metals, trace stone or ceramic items or matter, and/or trace pathogens. These substances are found in all recycled glass cullet products.

Another embodiment of the method of the present invention to directly create a glass cullet that is free from contaminants. Glass production facilities add crushed recycled glass cullet into the new glass production process to reduce the heat required to melt the silica sand and the melt temperature of the silica sand. The problem with this glass cullet is that it may include contaminants from the glass recycle process. An embodiment of the method of the present invention is to produce clean glass cullet directly from crystalline silica sand. This “pre-reacted” batch material that can be added to batch glass (much as glass cullet is used today) that will lower the melt temperature of batch glass.

The amorphous silica sand, gravel, or other particles may be used in the manufacture of many products. For example, crystalline free silica foam glass and ceramics may be produced. An embodiment of the method for production of crystalline free foamed glass may comprise blending fine amorphous silica sand or ground amorphous silica sand with a blowing agent to form a foam glass precursor. The blowing agent may be any compound that produces an off-gas during heating at furnace temperatures. The blowing agent may be, but is not limited to, carbon or limestone, for example.

The method may further comprise heating the foam glass precursor in the furnace to cause the blowing agents to out-gas, thus expanding or foaming the molten mass. The molten mass is cooled and annealed to freeze the gas pockets creating a lightweight product. Foamed glass in the melted state can be formed into many products including insulation, blocks, brick, or aggregate for construction or agriculture.

The new “virgin” amorphous silica glass cullet product would compete directly with recycled glass cullet. The advantage of the embodied “pre-reacted” batch material would be it would be 100% free of deleterious materials such as rock, ceramic, metals, or lead that cullet producers go to a lot of work to ensure don't get into their cullet in excessive quantities.

As used herein, the term “no trace” means that the component is below measurement limits of instruments typically used to determine the concentration of the component.

As used herein, “amorphous silica sand” means a silica product comprising less than 2 wt. % of crystalline silica in a primarily amorphous silica product, in a more specific embodiment, “amorphous silica sand” means a silica product comprising less than 1 wt. % of crystalline silica in a primarily amorphous silica product; and in an even more specific embodiment for blasting products, for example, “amorphous silica sand” means a silica product comprising less than 0.5 wt. % of crystalline silica in a primarily amorphous silica product.

Stabilizers may be added to the glass batch to reduce the water solubility of the resultant amorphous silica products. Stabilizers include, but are not limited to, calcium carbonate (lime), for example. Other components that may be mixed with the crystalline silica to produce the glass batch include a number of metal oxides to produce desired properties in the amorphous silica products. For example, alumina (Al2O3) may be added to the glass batch to provide increased durability of the amorphous silica products produced from the glass batch. Boron oxide (B2O3) may be a glass former like silica and increases the chemical resistance of the glass.

The melting point reducing agents may include, but is not limited to, sodium carbonate, sodium nitrate, iron oxide, iron silicates, potash, potassium carbonate, calcium carbonate, colemanite, sodium oxide, calcium oxide, magnesia, alumina, aluminum oxides, alumina silicates, lead oxide, alkali metals, lithium, sodium, potassium, rubidium, cesium, francium, and combinations thereof.

Additional fluxes may include materials such as naturally occurring products that contain these reducing agents such as, but not limited to, feldspar, alumina silicates comprising iron, bauxite, clays, ball clays, Kentucky or Tennessee clay, and kaolin, for example. Clay may be a finely-grained natural rock or soil material that combines one or more clay minerals with possible traces of quartz (SiO2), metal oxides (Al2O3, MgO etc.) and organic matter. Ball clays are typically kaolinitic sedimentary clays that commonly consist of 20-80% kaolinite, 10-25% mica, 6-65% quartz. Another flux may be bauxite.

For example, sodium carbonate and potassium carbonate may lower the melting point of crystalline silica to about 1,000° C. (1830° F.) in certain concentrations and may be added to make the melting process more efficient.

Sodium carbonate increases the viscosity of the glass melt at a given temperature but is relatively expensive. Additionally, mixing sodium carbonate into the crystalline silica glass batch (and/or another melting point reducing agent), without the addition of a stabilizing agent such as, but not limited to lime, may cause the amorphous silica products to be at least slightly water soluble. Water soluble amorphous silica products may be more environmentally friendly that insoluble amorphous silica. Thus, a method of producing a water-soluble amorphous silica sand, gravel, or other particles comprises mixing a temperature reducing agent with crystalline silica without the addition of a stabilizer such as calcium carbonate and melting the batch glass to produce an amorphous silica product to be water soluble.

Density and Hardness Affecting Components

Embodiment of the amorphous silica products may comprise metals or metal oxides. These metals and metal oxides include refractory metals, iron, titanium, vanadium, chromium, manganese, zirconium, zircon, niobium, molybdenum, ruthenium, rhodium, hafnium, tantalum, tungsten, rhenium, osmium, iridium, and oxides or silicates of these metals, for example.

Additional metals include aluminum, aluminum oxides, aluminum silicates. The alumina may be from clay and, in some embodiments, low alkali clay. Some clays are up to 10% alumina

Embodiments of the amorphous silica products may comprise components that change the hardness of the resultant amorphous silica products. Alkalis and lead oxides will decrease hardness in the resultant amorphous product, whereas addition of CaO, MgO, ZnO, Al2O3, B2O3, zirconium, zircon, zirconium oxides, iron and iron oxides will result in amorphous silica products with greater hardness.

### EXAMPLES

Cullet was obtained from a glass recycling facility. The composition of the cullet was approximately as follows:

Typical Cullet Composition

| | |
|---|---|
| SiO2 | 74. wt. % |
| MgO | 0.3 wt. % |
| CaO | 11.3 wt. % |
| NaO | 13 wt. % |
| K2O | 0.2 wt. % |
| Al2O3 | 0.7 wt. % |
| Fe2O3 | 0.01 wt. % |

In embodiments of the glass formulations, the silicon oxides may be added in the form of cullet, sand, other sources of silicon oxides, or combinations thereof.

The melts were performed in a [Make and Model of Furnace] CF1700 muffle furnace manufactured by Across International.

### Example 1

A melt batch (Sample 2789) was prepared comprising the following composition, silica dioxide (SiO2) at 85 wt. %, sodium oxide (NaO) at 14 wt. %, and iron oxide (Fe2O3) at 1 wt. % in the melt batch.

The melt batch was melted in a crucible in a batch furnace at approximately 1525° C. The melted batch was then quenched in water. The solidified glass was sent for analysis for specific gravity and hardness. The specific gravity was determined to be 2.25. The Knoop hardness was determined to be 481.8.

### Example 2

A melt batch (Sample 2790) was prepared comprising the following composition, silica dioxide (SiO2) at 84 wt. %, zirconium oxide (ZrO) at 13 wt. %, sodium oxide (NaO) at 1 wt. %, and iron oxide (Fe2O3) at 2 wt. % in the melt batch.

The melt batch was melted in a crucible in a batch furnace at approximately 1550° C. The melted batch was then quenched in water. The solidified glass was sent for analysis for specific gravity and hardness. The specific gravity was determined to be 2.36. The Knoop hardness was determined to be 493.7.

### Example 3

A melt batch (Sample 2791) was prepared comprising the following composition, silica dioxide (SiO2) at 83 wt. %, zirconium oxide (ZrO) at 2 wt. %, sodium oxide (NaO) at 10 wt. %, and iron oxide (Fe2O3) at 5 wt. % in the melt batch.

The melt batch was melted in a crucible in a batch furnace at approximately 1575° C. The melted batch was then quenched in water. The solidified glass was sent for analysis for specific gravity and hardness. The specific gravity was determined to be 2.35. The Knoop hardness was determined to be 540.6.

### Example 4

A melt batch (Sample 2792) was prepared comprising the following composition, silica dioxide (SiO2) at 80 wt. %, zirconium oxide (ZrO) at 5 wt. %, sodium oxide (NaO) at 5 wt. %, and iron oxide (Fe2O3) at 10 wt. % in the melt batch.

The melt batch was melted in a crucible in a batch furnace at approximately 1625° C. The melted batch was then quenched in water. The solidified glass was sent for analysis for specific gravity and hardness. The specific gravity was determined to be 2.86. The Knoop hardness was determined to be 638.4.

### Example 5

A melt batch (Sample 2799) was prepared comprising the following composition, silica dioxide (SiO2) at 70 wt. %, zirconium oxide (ZrO) at 2 wt. %, sodium oxide (NaO) at 5 wt. %, aluminum oxide (Al2O3) at 3 wt. %, and iron oxide (Fe2O3) at 20 wt. % in the melt batch.

The melt batch was melted in a crucible in a batch furnace at approximately 1600 to 1625° C. The melted batch was then quenched in water. The solidified glass was sent for analysis for specific gravity and hardness. The specific gravity was determined to be 2.5. The Knoop hardness was determined to be 615.4.

### Example 6

A melt batch (Sample 2800) was prepared comprising the following composition, silica dioxide (SiO2) at 65 wt. %, zirconium oxide (ZrO) at 2 wt. %, sodium oxide (NaO) at 4 wt. %, aluminum oxide (Al2O3) at 6 wt. %, and iron oxide (Fe2O3) at 23 wt. % in the melt batch.

The melt batch was melted in a crucible in a batch furnace at approximately 1600 to 1625° C. The melted batch was then quenched in water. The solidified glass was sent for analysis for specific gravity and hardness. The specific gravity was determined to be 2.69. The Knoop hardness was determined to be 668.7.

### Example 7: Melt Batch from Sand

A melt batch (Sample 2801) was prepared comprising the following composition, silica dioxide (SiO2) at 60 wt. %, zirconium oxide (ZrO) at 2 wt. %, sodium oxide (NaO) at 3 wt. %, aluminum oxide (Al2O3) at 8 wt. %, and iron oxide (Fe2O3) at 27 wt. % in the melt batch.

The melt batch was melted in a crucible in a batch furnace at approximately 1600 to 1625° C. The melted batch was then quenched in water. The solidified glass was sent for analysis for specific gravity and hardness. The specific gravity was determined to be 2.52. The Knoop hardness was determined to be 721.9.

### Example 8: Melt Batch from Cullet

A melt batch (Sample 2802) was prepared comprising the following composition, cullet (approximate composition above) at 90 wt. %, zirconium oxide (ZrO) at 2 wt. %, aluminum oxide (Al2O3) at 3 wt. %, and iron oxide (Fe2O3) at 5 wt. % in the melt batch.

The melt batch was melted in a crucible in a batch furnace at approximately 1600 to 1625° C. The melted batch was then quenched in water. The solidified glass was sent for analysis for specific gravity and hardness. The specific gravity was determined to be 2.50. The Knoop hardness was determined to be 622.

### Example 9: Melt Batch from Cullet

A melt batch (Sample 2803) was prepared comprising the following composition, cullet (approximate composition above) at 80 wt. %, zirconium oxide (ZrO) at 3 wt. %, aluminum oxide (Al2O3) at 4.5 wt. %, and iron oxide (Fe2O3) at 12.5 wt. % in the melt batch.

The melt batch was melted in a crucible in a batch furnace at approximately 1600 to 1625° C. The melted batch was then quenched in water. The solidified glass was sent for analysis for specific gravity and hardness. The specific gravity was determined to be 2.54. The Knoop hardness was determined to be 651.9.

### Example 10: Melt Batch from Cullet

A melt batch (Sample 2804) was prepared comprising the following composition, cullet (approximate composition above) at 70 wt. %, zirconium oxide (ZrO) at 4 wt. %, aluminum oxide (Al2O3) at 6 wt. %, and iron oxide (Fe2O3) at 20 wt. % in the melt batch.

The melt batch was melted in a crucible in a batch furnace at approximately 1600 to 1625° C. The melted batch was then quenched in water. The solidified glass was sent for analysis for specific gravity and hardness. The specific gravity was determined to be 2.71. The Knoop hardness was determined to be 654.8.

### Example 11: Melt Batch from Sand

A melt batch (Sample 2809) was prepared comprising the following composition, silica dioxide (SiO2) at 62.45 wt. %, magnesium oxide (MgO) at 0.3 wt. %, calcium oxide (CaO) at 0.2 wt. %, sodium oxide (NaO) at 7 wt. %, potassium oxide (KO) at 0.05 wt. %, and iron oxide (Fe2O3) at 30 wt. % in the melt batch.

The melt batch was melted in a crucible in a batch furnace at approximately 1625° C. A portion of the melted batch was then quenched in water (Sample 2809Q) and a portion of the melted batch was air cooled (Sample 2809A).

The solidified glass was sent for analysis for specific gravity and hardness. The specific gravity for Sample 2809Q was determined to be 2.534 and its Knoop hardness was determined to be 552.1.

The specific gravity for Sample 2809A was determined to be 2.864 and its Knoop hardness was determined to be 570.6.

### Example 12: Melt Batch from Sand

A melt batch (Sample 2810) was prepared comprising the following composition, silica dioxide (SiO2) at 57.45 wt. %, magnesium oxide (MgO) at 0.3 wt. %, calcium oxide (CaO) at 0.2 wt. %, sodium oxide (NaO) at 6.14 wt. %, potassium oxide (KO) at 0.05 wt. %, and iron oxide (Fe2O3) at 35 wt. % in the melt batch.

The melt batch was melted in a crucible in a batch furnace at approximately 1625° C. A portion of the melted batch was then quenched in water (Sample 2810Q) and a portion of the melted batch was air cooled (Sample 2810A).

The solidified glass was sent for analysis for specific gravity and hardness. The specific gravity for Sample 2810Q was determined to be 2.858 and its Knoop hardness was determined to be 580.8.

The specific gravity for Sample 2810A was determined to be 2.826 and its Knoop hardness was determined to be 586.4.

### Example 12

A melt batch may be prepared comprising the following composition, silica dioxide (SiO2) at 42.3 wt. %, magnesium oxide (MgO) at 0.3 wt. %, calcium oxide (CaO) at 0.2 wt. %, sodium oxide (NaO) at 6.14 wt. %, wt. %, and iron oxide (Fe2O3) at 50 wt. % in the melt batch.

### Further Examples

Additional amorphous silica products were produced from batches as described in the tables below. The examples exemplify the methods used to produce the amorphous silica products from crystalline silica, amorphous silica and combinations of amorphous and crystalline silica.

The examples demonstrate the use of iron oxides and/or limestone can cheaply increase the density of these products over the silica sand and cullet.

Primary Network Former: Cullet
Crucible: Alumina or Graphite

| | | | | | | Iron (III) | | | | | | | |
|---|---|---|---|---|---|---|---|---|---|---|---|---|---|
| Melt | Specific | Knoop | Temp. | | | Oxide | Magne- | Iron Ore | Calcium | Lime- | Sodium | Potassium | Char- |
| # | Gravity | Hardness | ° C. | Crucible | Cullet | Fe2O3 | tite | (Taconite) | Carbonate | stone | Carbonate | Carbonate | coal |
| 108 | 2.67 | | 1200 | Alumina | 65.00% | | 30.00% | | | 0.00% | 5.00% | 0.00% | 0.00% |
| 109 | 2.70 | | 1200 | Alumina | 68.00% | | 32.00% | | | 0.00% | 0.00% | 0.00% | 0.00% |
| 111 | 2.77 | 539.4 | 1200 | Alumina | 65.00% | | 30.00% | | | 3.00% | 0.00% | 0.00% | 2.00% |
| 112 | 2.80 | 554.1 | 1290 | Alumina | 65.00% | | 30.00% | | 0.00% | 5.00% | 0.00% | 0.00% | |
| 41 | 2.74 | 589.8 | 1290 | Alumina | 65.00% | | 30.00% | | 0.00% | 0.00% | 5.00% | 0.00% | |
| 41 | 2.68 | | 1200 | Alumina | 65.00% | | 30.00% | | 0.00% | 0.00% | 5.00% | 0.00% | |
| 41 | 2.69 | | 1290 | Alumina | 65.00% | | 30.00% | | 0.00% | 0.00% | 5.00% | 0.00% | |
| 43 | 2.70 | | 1280 | Alumina | 66.67% | | 28.57% | | 0.00% | 0.00% | 4.76% | 0.00% | |
| 45 | 2.78 | | 1290 | Alumina | 46.00% | | 30.00% | | 0.00% | 12.00% | 12.00% | 0.00% | |
| 47 | 2.77 | | 1290 | Alumina | 26.00% | | 29.00% | | 0.00% | 36.40% | 8.60% | 0.00% | |
| 51 | 2.72 | | 1290 | Alumina | 30.00% | | 30.00% | | 30.00% | 0.00% | 0.00% | 10.00% | |
| 94 | 2.72 | | 1290 | Alumina | 68.00% | | 32.00% | | 0.00% | 0.00% | 0.00% | 0.00% | |
| 110 | 2.70 | | 1200 | Alumina | 65.00% | 0.00% | 30.00% | | | 3.00% | | | 2.00% |
| 95 | 2.78 | | 1380 | Alumina | 63.00% | 0.00% | 32.00% | | | 0.00% | | | 5.00% |
| 96 | 2.67 | | 1290 | Alumina | 63.00% | 32.00% | 0.00% | | | 0.00% | | | 5.00% |
| 103 | 2.78 | | 1290 | Alumina | 63.00% | 0.00% | 32.00% | | | 0.00% | | | 5.00% |
| 104 | 2.81 | 530.8 | 1290 | Alumina | 63.00% | 0.00% | 32.00% | | | 3.00% | | | 2.00% |
| 113 | 2.81 | | 1390 | Alumina | 63.00% | 0.00% | 31.00% | | | 4.00% | | | 2.00% |
| 114 | 3.01 | | 1390 | Alumina | 65.00% | 0.00% | 30.00% | | | 3.00% | | | 2.00% |
| 85 | 2.64 | | 1380 | Alumina | 20.08% | 35.66% | 0.00% | | | 36.43% | 0.00% | 7.83% | 0.00% |
| 91 | 3.24 | | 1390 | Alumina | 18.78% | 0.00% | 33.35% | | | 34.07% | 0.00% | 7.32% | 6.48% |
| 99 | 2.69 | | 1480 | Alumina | 23.64% | 0.00% | 26.36% | | | 33.09% | 7.82% | 0.00% | 9.09% |
| 105 | 3.18 | 473.2 | 1390 | Alumina | 24.64% | 0.00% | 30.45% | | | 33.09% | 7.82% | 0.00% | 4.00% |
| 42 | 2.73 | | 1380 | Alumina | 49.00% | | | 33.00% | | 6.00% | 0.00% | 12.00% | 0.00% |
| 22 | 3.07 | 646.2 | 1380 | Alumina | 18.78% | | | 33.35% | | 34.07% | 0.00% | 7.32% | 6.48% |
| 23 | 3.02 | | 1380 | Alumina | 25.00% | | | 50.00% | | 13.00% | 0.00% | 12.00% | 0.00% |
| 31 | 2.95 | 533.1 | 1430 | Alumina | 27.92% | | | 26.34% | | 37.65% | 0.00% | 8.09% | 0.00% |
| 32 | 2.97 | 567.3 | 1380 | Alumina | 27.97% | | | 26.27% | | 37.66% | 0.00% | 8.09% | 0.00% |
| 33 | 2.93 | | 1380 | Alumina | 26.00% | | | 29.00% | | 36.43% | 0.00% | 8.57% | 0.00% |
| 34 | 2.89 | | 1380 | Alumina | 22.37% | | | 29.01% | | 34.61% | 0.00% | 7.43% | 6.58% |
| 35 | 2.87 | | 1380 | Alumina | 43.00% | | | 26.00% | | 19.00% | 12.00% | 0.00% | 0.00% |
| 36 | 2.87 | 576.8 | 1380 | Alumina | 55.00% | | | 40.00% | | 0.00% | 0.00% | 5.00% | 0.00% |
| 37 | 2.85 | | 1290 | Alumina | 25.40% | | | 30.30% | | 34.30% | 0.00% | 10.00% | 0.00% |
| 38 | 2.83 | | 1380 | Alumina | 43.00% | | | 26.00% | | 19.00% | 0.00% | 12.00% | 0.00% |
| 39 | 2.79 | | 1380 | Alumina | 45.00% | | | 30.00% | | 13.00% | 0.00% | 12.00% | 0.00% |
| 40 | 2.76 | | 1380 | Alumina | 50.00% | | | 38.00% | | 0.00% | 0.00% | 12.00% | 0.00% |
| 1 | 2.54 | | 1409 | Graphite | 60.00% | 40.00% | 0.00% | | | | | | |
| 2 | 2.44 | | 1450 | Graphite | 70.00% | 30.00% | 0.00% | | | | | | |
| 3 | 2.32 | | 1450 | Graphite | 80.00% | 20.00% | 0.00% | | | | | | |
| 4 | 2.45 | | 1450 | Graphite | 90.00% | 10.00% | 0.00% | | | | | | |
| 20 | 3.13 | | 1380 | Graphite | 26.05% | 0.00% | 24.58% | | | 35.14% | 0.00% | 7.55% | 6.68% |
| 21 | 3.13 | | 1380 | Graphite | 27.92% | 0.00% | 26.34% | | | 37.65% | 0.00% | 8.09% | 0.00% |

Primary Network Former: Silica Sand
Crucible: Alumina

| Melt | Specific | Knoop | | | | Iron (III) | | | Sodium | Potassium | |
|---|---|---|---|---|---|---|---|---|---|---|---|
| # | Gravity | Hardness | Temp. ° C. | Crucible | Sand | Oxide Fe2O3 | Magnetite | Limestone | Carbonate | Carbonate | Charcoal |
| 86 | 2.67 | | 1480 | Alumina | 14.57% | 34.52% | 0.00% | 33.31% | 4.43% | 7.16% | 6.02% |
| 87 | 3.10 | | 1480 | Alumina | 14.57% | 34.52% | 0.00% | 33.31% | 4.43% | 7.16% | 6.02% |
| 88 | 3.16 | | 1480 | Alumina | 14.57% | 0.00% | 34.52% | 33.31% | 4.43% | 7.16% | 6.02% |
| 89 | 3.23 | 585.5 | 1390 | Alumina | 14.57% | 0.00% | 34.52% | 33.31% | 4.43% | 7.16% | 6.02% |
| 100 | 3.23 | | 1390 | Alumina | 15.50% | 0.00% | 36.74% | 35.44% | 4.71% | 7.61% | 0.00% |
| 106 | 3.08 | | 1390 | Alumina | 15.50% | 0.00% | 36.73% | 35.45% | 4.72% | 7.61% | 0.00% |
| 90 | 3.35 | 617.6 | 1390 | Alumina | 10.20% | 4.37% | 34.52% | 33.31% | 4.43% | 7.16% | 6.02% |
| 93 | 3.32 | | 1390 | Alumina | 10.20% | 4.37% | 34.52% | 33.31% | 4.43% | 7.16% | 6.02% |

Primary Network Former: Silica Sand or Cullet, and Mineral Slag
Crucible: Alumina

| Melt | Specific | Knoop | | | | | | | | Magnesium | Calcium | |
|---|---|---|---|---|---|---|---|---|---|---|---|---|
| # | Gravity | Hardness | Temp. ° C. | Crucible | Sand | Cullet | Coal Slag | Nickel Slag | Magnetite | Oxide | Carbonate | Limestone |
| 58 | 2.82 | | 1390 | Alumina | | 20.00% | 0.00% | 60.00% | 15.00% | 0.00% | 5.00% | 0.00% |
| 62 | 2.63 | | 1480 | Alumina | | 40.00% | 50.00% | 0.00% | 5.00% | 0.00% | 5.00% | 0.00% |
| 64 | 2.87 | | 1480 | Alumina | | 10.00% | 0.00% | 50.00% | 30.00% | 0.00% | 10.00% | 0.00% |
| 65 | 2.54 | | 1480 | Alumina | | 20.00% | 50.00% | 0.00% | 5.00% | 10.00% | 0.00% | 15.00% |
| 73 | 2.84 | | 1480 | Alumina | | 19.05% | 47.62% | 0.00% | 23.81% | 0.00% | 0.00% | 9.52% |
| 75 | 2.77 | | 1390 | Alumina | | 19.05% | 57.14% | 0.00% | 14.29% | 0.00% | 0.00% | 9.52% |
| 117 | 2.98 | | 1390 | Alumina | | 11.00% | 50.00% | 0.00% | 25.00% | 0.00% | 0.00% | 14.00% |
| 118 | 2.89 | | 1390 | Alumina | | 9.00% | 60.00% | 0.00% | 22.00% | 0.00% | 0.00% | 9.00% |
| 119 | 3.01 | | 1480 | Alumina | | 12.00% | 0.00% | 50.00% | 20.00% | 0.00% | 0.00% | 18.00% |
| 120 | 2.88 | | 1480 | Alumina | | 15.00% | 0.00% | 60.00% | 15.00% | 0.00% | 0.00% | 10.00% |
| 121 | 2.95 | 725.8 | 1480 | Alumina | 11.00% | | 50.00% | | 25.00% | | | 14.00% |
| 122 | 2.88 | | 1480 | Alumina | 12.00% | | 50.00% | | 20.00% | | | 18.00% |

Primary Network Former: Silica Sand or Cullet and Recycled Concrete
Crucible: Alumina

| Melt | Specific | Knoop | Temp. | | | | Recycled | | | |
|---|---|---|---|---|---|---|---|---|---|---|
| # | Gravity | Hardness | ° C. | Crucible | Sand | Cullet | Concrete | Magnetite | Limestone | Charcoal |
| 123 | 2.73 | | 1480 | Alumina | 0.00% | 10.00% | 40.00% | 35.00% | 15.00% | 0.00% |
| 135 | 2.87 | | 1480 | Alumina | 0.00% | 9.50% | 38.00% | 33.25% | 14.25% | 5.00% |
| 136 | 3.10 | 679.1 | 1390 | Alumina | 10.00% | 0.00% | 40.00% | 35.00% | 15.00% | 0.00% |
| 139 | 3.12 | 625.9 | 1390 | Alumina | 0.00% | 0.00% | 60.00% | 30.00% | 5.00% | 5.00% |

Primary Network Former: Cullet and Alumina
Crucible: Graphite or Alumina

| | | | | | | Iron (III) | | | | | |
|---|---|---|---|---|---|---|---|---|---|---|---|
| Melt | Specific | | | | | Oxide | Recycled | Calcium | Potassium | Sodium | |
| # | Gravity | Temp. ° C. | Crucible | Cullet | Alumina | Fe2O3 | Iron/Steel | Oxide | Sulfate | Carbonate | Charcoal |
| 7 | 2.73 | 1400 | Graphite | 60.70% | 3.10% | 30.10% | 0.00% | 0.00% | 6.10% | 0.00% | |
| 8 | 2.76 | 1400 | Graphite | 58.70% | 5.10% | 30.10% | 0.00% | 0.00% | 6.10% | 0.00% | |
| 9 | 2.79 | 1400 | Graphite | 53.70% | 5.10% | 30.10% | 0.00% | 5.00% | 6.10% | 0.00% | |
| 10 | 2.69 | 1380 | Graphite | 36.80% | 3.10% | 45.00% | 0.00% | 5.00% | 6.10% | 4.00% | |
| 11 | 2.64 | 1380 | Graphite | 53.70% | 5.10% | 22.00% | 6.00% | 7.10% | 6.10% | 0.00% | |
| 12 | 2.74 | 1380 | Graphite | 53.70% | 5.10% | 29.10% | 1.00% | 5.00% | 6.10% | 0.00% | |
| 13 | 2.69 | 1380 | Graphite | 53.70% | 5.10% | 30.10% | 0.00% | 5.00% | 6.10% | 0.00% | |
| 14 | 2.63 | 1380 | Graphite | 53.70% | 5.10% | 30.10% | 0.00% | 5.00% | 0.00% | 6.10% | |
| 15 | 2.71 | 1380 | Graphite | 53.70% | 5.10% | 29.10% | 0.00% | 5.00% | 6.10% | 0.00% | 1.00% |
| 16 | 2.71 | 1380 | Graphite | 53.70% | 5.10% | 29.10% | 0.00% | 5.00% | 6.10% | 0.00% | 1.00% |
| 17 | 2.76 | 1380 | Graphite | 53.70% | 5.10% | 29.10% | 0.00% | 5.00% | 6.10% | 0.00% | 1.00% |
| 18 | 2.75 | 1380 | Graphite | 53.70% | 5.10% | 29.10% | 0.00% | 5.00% | 6.10% | 0.00% | 1.00% |
| 19 | 2.79 | 1380 | Graphite | 53.70% | 5.10% | 29.10% | 0.00% | 5.00% | 6.10% | 0.00% | 1.00% |

Primary Network Former: Cullet and Iron-Alumina Silicate (Garnet)
Crucible: Graphite or Alumina

| Melt | Specific | Knoop | | | | | Iron (III) | Sodium | Potassium | |
|---|---|---|---|---|---|---|---|---|---|---|
| # | Gravity | Hardness | Temp. ° C. | Crucible | Cullet | Garnet | Oxide Fe2O3 | Carbonate | Sulfate | Charcoal |
| 5 | 2.66 | | 1400 | Graphite | 53.50% | 13.13% | 24.81% | 0.00% | 8.56% | 0.00% |
| 6 | 2.74 | | 1400 | Graphite | 47.18% | 22.86% | 21.40% | 0.00% | 8.56% | 0.00% |
| 84 | 2.67 | 667.4 | 1480 | Alumina | | 95.00% | | 5.00% | | |

The embodiments of the described amorphous silica products and method are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A method of producing a manufactured glass article, comprising:
preparing a batch comprising:
glass cullet in a concentration range of 50 wt. % to 75 wt. %;
iron oxide in a concentration range of 20 wt. % to 40 wt. %; and
fluxes in a concentration range of 5 wt. % to 40 wt. %;
melting the batch in a furnace to melt effluent; and
cooling the melt effluent to form amorphous silica particles, mass or product.

2. The method of claim 1, wherein the batch comprises a combustible material.

3. The method of claim 1, wherein the batch comprises at least one of charcoal or coal in a concentration range.

4. The method of claim 1, wherein the iron oxide comprises magnetite.

5. The method of claim 1, wherein the iron oxide consists essentially of magnetite.

6. The method of claim 1, comprising crushing the amorphous silica particles, mass or product to form glass particles.

7. The method of claim 6, wherein the magnetite is in a concentration of 20 wt. % to 35 wt. %.

8. The method of claim 7, wherein the batch comprises at least one of limestone and calcium oxide.

9. The method of claim 7, wherein the limestone in a concentration of 10 wt. % to 40 wt. %

10. The method of claim 7, wherein the limestone in a concentration of 25 wt. % to 40 wt. %

11. The method of claim 1, wherein the glass cullet is in a concentration range of 50 wt. % to 65 wt. %.

12. The method of claim 1, wherein the glass cullet is in a concentration range of 55 wt. % to 65 wt. %.

13. The method of claim 1, wherein the iron oxide consists essentially of magnetite.

14. The method of claim 13, wherein the magnetite is in a concentration of 20 wt. % to 35 wt. %.

15. The method of claim 14, wherein the batch comprises at least one of limestone and calcium oxide.

16. The method of claim 14, wherein the limestone in a concentration of 10 wt. % to 40 wt. %

17. The method of claim 14, wherein the limestone in a concentration of 25 wt. % to 40 wt. %

18. The method of claim 1, wherein the amorphous silica particles, mass or product have a density greater than 2.65 g/ml.

19. The method of claim 1, wherein the amorphous silica particles, mass or product have a density greater than 2.80 g/ml.

20. The method of claim 1, wherein the amorphous silica particles, mass or product have a density greater than 3.0 g/ml.

21.-220. (canceled)
